(19) United States
(12) Patent Application Publication
(10) Pub. No.: US 2018/0330408 A1
(43) Pub. Date: Nov. 15, 2018

(54) PREDICTIVE ANALYSIS FOR CONTROLLING REAL-TIME ADVERTISING PLACEMENT

(71) Applicant: Engine Media, LLC, Princeton, NJ (US)

(72) Inventor: Dominic Bennett, Los Altos, CA (US)

(73) Assignee: Engine Media, LLC, Princeton, NJ (US)

(21) Appl. No.: 15/979,733

(22) Filed: May 15, 2018

Related U.S. Application Data
(60) Provisional application No. 62/506,292, filed on May 15, 2017.

(51) Int. Cl. G06Q 30/02; G06F 17/30

(52) U.S. Cl. CPC G06Q 30/0277; G06F 17/30864

(57) ABSTRACT

Advertising based on real-time audience is disclosed. For example, first and second network accessible devices, associated with a common user attribute of a plurality of users is quantified. A first publisher is selected based on comparing inventory attributes of first and second publishers, to deliver the advertisement to a first user selected based on user attributes, including reserving a first advertisement slot used to send the advertisement. A determination is made whether a target audience size for the advertisement has been fulfilled. If the target audience size for the advertisement is fulfilled, a consumption result of the advertisement is reported. If the target audience size for the advertisement is unfulfilled, the first publisher is selected based on comparing inventory attributes of the first and second publishers to deliver the advertisement to a second user selected based on user attributes, including reserving a second advertisement slot used to send the advertisement.

### CROSS REFERENCE TO RELATED APPLICATION

The present application is a non-provisional of U.S. Provisional Application Ser. No. 62/506,292, filed May 15, 2017, the entire disclosure of which is hereby incorporated by reference herein.

### BACKGROUND

The present disclosure generally relates to advertising on network accessible devices. As microprocessors have become more efficient, and network connectivity more prevalent, an ever increasing amount of devices now have internet or intranet enabled capabilities and features. With the network capabilities of network accessible devices, come opportunities for users to consume content, and therefore opportunities for publishers of content to advertise to these users. Advertisers are presented with ever increasing opportunities to reach their increasingly accessible consumers through a myriad of network accessible devices used by these consumers on a daily basis. However, advertisers, to control advertisement campaigns, want to improve predictions of how they will perform before starting them.

### SUMMARY

The present disclosure provides a new and innovative system, methods and apparatus for predictive analysis for controlling real-time advertising placements. In an example, a quantity of network accessible devices in a plurality of network accessible devices is determined, where each network accessible device of the plurality of network accessible devices is associated with at least one user associated with at least one user attribute that is shared among each of the plurality of network accessible devices. The plurality of network accessible devices includes both a first network accessible device and a second network accessible device. A first user to receive an advertisement is selected based on a first plurality of user attributes. A first publisher to deliver the advertisement to the first user is selected based on a comparison of a first plurality of inventory attributes of the first publisher and a second plurality of inventory attributes of a second publisher. A first advertisement slot to send the advertisement to the first network accessible device is reserved from the first publisher. The advertisement is sent to the first network accessible device. A determination is made whether a target audience size for the advertisement has been fulfilled. In response to determining that the target audience size for the advertisement is fulfilled, a consumption result of the advertisement is reported. In response to determining that the target audience size for the advertisement is unfulfilled, a second user to receive the advertisement is selected, based on a second plurality of user attributes. The first publisher is selected to deliver the advertisement to the second user based on a comparison of the first plurality of inventory attributes and the second plurality of inventory attributes. A second advertisement slot is reserved from the first publisher to send the advertisement to the second network accessible device. The advertisement engine sends the advertisement to the second network accessible device.

The present disclosure additionally provides a new and innovative system, methods and apparatus for verifying the results of the predictive analysis prior to committing to a real-time advertisement placement. In an example, a notice of an ad opportunity associated with a network accessible device is received, where the notice includes a plurality of opportunity attributes. A user profile repository is queried based on the plurality of opportunity attributes. A first opportunity attribute of the plurality of opportunity attributes is determined to be associated with a first user attribute associated with an ad campaign based on the notice and/or a results of querying the user profile repository. Responsive to determining that the first opportunity attribute is associated with the first user attribute, respond to the notice to select the network accessible device to receive an advertisement. A probe is sent to the network accessible device to verify whether the network accessible device is associated with a second user attribute associated with the ad campaign. Responsive to determining that the network accessible device is associated with the second user attribute, send the advertisement to the network accessible device for display. Responsive to determining a lack of association between the network accessible device and the second user attribute, cancel sending the advertisement to the network accessible device.

Additional features and advantages of the disclosed method and apparatus are described in, and will be apparent from, the following Detailed Description and the Figures.

### BRIEF DESCRIPTION OF THE FIGURES

FIG. 1A is a block diagram of the delivery of advertisements in a system performing predictive analysis for controlling real-time advertising placements according to an example of the present disclosure.

FIG. 1B is a block diagram of an example system with an advertisement engine performing predictive analysis for controlling real-time advertising placements according to an example of the present disclosure.

FIG. 1C is a block diagram of an example system where an advertisement engine performs predictive analysis and then verifying the results of the predictive analysis prior to committing to a real-time advertisement placement according to an example of the present disclosure.

FIG. 2A is a block diagram of user selection in a system performing predictive analysis for controlling real-time advertising placements according to an example of the present disclosure.

FIG. 2B is a block diagram of publisher selection in a system performing predictive analysis for controlling real-time advertising placements according to an example of the present disclosure.

FIG. 3A is a flowchart illustrating an example of performing predictive analysis for controlling real-time advertising placements according to an example of the present disclosure.

FIG. 3B is a flowchart illustrating an example of performing predictive analysis for controlling real-time advertising placements and verifying the results of the predictive analysis prior to committing to a real-time advertisement placement according to an example of the present disclosure.

FIGS. 4A, 4B, 4C, and 4D are flow diagrams illustrating advertisement delivery and publisher selection in a system performing predictive analysis for controlling real-time advertising placements according to an example of the present disclosure.

FIGS. 5A and 5B are flow diagrams illustrating advertisement delivery in a system performing verified predictive analysis for controlling real-time advertising placements according to an example of the present disclosure.

### DETAILED DESCRIPTION OF EXAMPLE EMBODIMENTS

As network accessible devices increasingly gain popularity, opportunities to advertise on such network accessible devices increase. With the vast variety of devices capable of presenting audio and visual advertisements (“ads”), come implementation challenges, especially as related to accurately determining whether a given advertising attempt has reached a targeted user. With a variety of devices, also comes a variety of preferential formats for advertising in each format, for example, a smart phone, a smart watch, and a tablet may be interacted with differently from a laptop or desktop computer, which may in turn be interacted with vastly differently from, for example, a display on a vending machine or a console in a car.

As a user uses a network accessible device, a robust history is generated regarding a variety of aspects of the user's life, including a vast array of demographic information as well as previous purchasing history. With the availability of such data, advertisers may target users with a much higher level of customization and particularity than through broadcast media (e.g., television advertising). As such, a collaborative, value added type of advertising environment may be created where advertisers partner with a user to find the products the user needs more efficiently. Therefore, in advertising on network accessible devices, advertising to the right users may be significantly more important than ensuring that a maximum quantity of users is reached through a given advertising campaign.

A strategy that may be used to try to reach members of a target audience may be to saturate publishers of content consumed by such a target audience with advertising slot purchases. However, such purchases fail to efficiently convert advertising slot purchases into advertisement conversions (e.g., click through, completed ad plays, increased sales, etc.). Similarly, targeting a network accessible device for an advertisement may fail to reach the proper user of a shared device. In a typical scenario, advertisements targeting such wide audiences may also fail to produce positive user engagement, often being considered irrelevant nuisances by their recipients.

In a typical example, an advertiser may have limited ways to reach a consumer directly. Typically, a publisher may publish content in which advertising may be embedded. In many examples, the addition of a publisher as an intermediary obfuscates the targeting of advertisements by an advertiser. For example, an advertiser may decide to work with a particular publisher (e.g., a financial news website) under the premise that such a website may be frequented by professionals working in the financial services industry who are likely to be affluent. However, targeting the website as a whole potentially wastes many advertising opportunities or impressions if the product being advertised is designer women's shoes. In a publisher scenario, an advertiser may have little control and/or insight into the actual impact of their advertising campaign since quantifying the number of ads shown to likely consumers (e.g., women 20-40 with significant disposable income) may be difficult or impossible to quantify. A result of low conversion rates due to improper advertisement targeting may be a commoditization of advertising opportunities or impressions, where publishers increase the quantity of ads in their content to generate revenue, resulting in negative user perception and user frustration.

Typically, a publisher serving content may coordinate with advertisers using a bidding process to display ads in content served to consumers of the publisher's content. A page of content, such as a web page on a web site, may include multiple ad slots where ads may be displayed. In an example, each ad slot, when loaded to a client device and viewed by a user of the client device may result in an ad impression. An ad impression may be an opportunity for an advertiser to reach a given user at a given time, and therefore each time a user loads a given page of content, and/or each time a different user loads the page of content, each ad slot on the page may become a new ad impression. In an example, a publisher may therefore request for advertisers to bid on each ad impression to maximize the value of each respective ad impression. For advertisers, ad agencies, and/or ad exchanges, response time to requests for bids on ad impressions may therefore be critical for maximizing both the likelihood of securing an ad impression as well as the effectiveness of a given ad impression. As users typically expect perceivably immediate responses when accessing content online, the entire process for negotiating, selecting, and displaying an ad may typically be completed in under one second. In a typical day, billions of ads may be served to consumers on network accessible devices. Publishers may be incentivized to maximize the quantity of advertisers bidding on each of their ad impressions to generate maximum value from each impression.

In a typical advertising exchange implementation, a user on a network accessible client device may access content supplied by a publisher. The publisher may incorporate ad slots in the content, and then seek prospective buyers (e.g., advertisers) for the ad impressions in the content in real-time while the content is loading, for example, by broadcasting an ad request for each ad slot loaded to the client device as an ad impression. An ad agency may, upon receipt of a request to bid on a given ad slot, seek advertisers either directly or through an advertising exchange to purchase the ad slot. For example, header bidding may be a typical implementation by which publishers and ad agencies request bids for and subsequently serve advertisements. A typical header bidding implementation may be based on the open source project Prebid.js where a typical request for bids on an ad slot may be in the form of a hypertext transfer protocol (“HTTP”) GET request with query string parameters related to the particular ad slot, such as a tag id, a referrer, and a size of the ad impression. For example, a header bidding request may be in the form of a Uniform Resource Locator (“URL”) without an additional message payload such as, http://www.example.com/getBid?tagid=55&referrer=mysite.com&width=300&height=250. In an example, an HTTP header associated with a request may include additional information pertinent to the request, such as User Agent, Content Type, Content Length, etc. In an example, requests for bids on an ad slot may also be in the form of an HTTP POST request. For example, in implementations based on the open source project OpenRTB, a bid may be in the form of an HTTP POST request with a JavaScript Object Notation (“JSON”) payload. A typical JSON payload for an ad slot bid may include attribute-value pairs conveying information regarding the particular ad slot, such as, {“tagid”; “55”, “referrer”: “mysite.com”, “dimensions”: {“width”: “300”, “height”: “250”}}. In various examples, different publishers and advertisers may implement different preferred formats of advertisement requests.

The present disclosure aims to address the delivery challenges for advertising on various network accessible devices by leveraging user attributes collected on individual users of network accessible devices, and inventory attributes aggregated by publishers based on the consumers of their content to deliver targeted, beneficial, customized advertisements with an increased conversion rate of advertisement attempts to advertisements consumed. In an example, by first employing filters on a database of users, an advertisement engine may determine with high specificity a list of potential target purchasers for a given product. The advertisement engine may then correlate the list of potential target purchasers with various publishers to determine publishers through which a given ad may be delivered to each potential target purchaser within the timeframe of an advertising campaign. In an example, based on the filters employed, an advertisement engine may determine in real-time with a high level of specificity a quantity of users identified as likely consumers of the advertised product that may be reached with an ad. The advertisement engine may then specifically target the pre-identified consumers for ads rather than canvassing all of the content consumers of a particular publisher. Advertisements may therefore be delivered with high specificity and for items and services pertinent to the user's current needs, with likely a much higher conversion rate of advertisement slots purchased to advertisements consumed. For example, through the installation of a filtering tool in the form of an advertisement engine at a specific location that is remote from the end-users and publishers who directly interface with the end users, with customizable filtering features specific to each end user, advertising based on real-time audience enables precisely targeted advertising campaigns maximizing electronic advertising efficiency. Improved targeting enables reduced total advertisements, resulting in improved battery life, reduced bandwidth usage, and reduced heat generation on network accessible devices, while improving quality of life metrics (e.g., reduced amount of time viewing poorly placed advertisements). By employing filtering on a user specific and/or user attribute specific level, content (e.g., advertisements) specific to a particular user can be generated and presented to the user, with feedback (e.g., consumption metrics) routed directly to the content producer (e.g., advertiser) thereby creating a user experience previously unobtainable while simultaneously streamlining content delivery to allow for bespoke, high value placements in place of a commoditized mass produced content experience. Therefore real-time audience quantification as disclosed improves upon existing methods of computerized content distribution and generation.

In many typical circumstances, especially due to the low latency requirements of bidding based ad placements (e.g., auction cycles of under 500 ms), publishers, ad exchanges, ad agencies, and advertisers may have imperfect information for targeting an ad. For example, a publisher with an ad slot available may send a notice of the opportunity to an ad agency, along with certain parameters and metadata describing the ad opportunity and the target device. The publisher may not have accurate information, and therefore an ad agency may not need to decide whether and how much to bid on an ad slot within 100 ms. As such, the ad agency may predictively bid on the ad slot based on currently available information that may be erroneous. An ad engine executing on the ad agency's server may, however, in the practice of the current disclosure, verify whether the selected network accessible device was accurately selected as a target for a given ad campaign. By verifying user attributes prior to loading an ad of the campaign to the network accessible device, an ad engine may then cancel a selected ad placement opportunity if targeting was erroneous. In an example, an ad engine may be required to obtain alternative content to display in the ad slot it obtained from the publisher. In the example, the ad engine may conduct a secondary auction with other advertisers for the ad slot. By enabling direct verification of user attributes from a network accessible device, the accuracy of ad campaign targeting may be greatly improved, and therefore advertisement efficiency is greatly improved with less computing resources expended on poorly targeted ads.

It should be appreciated that, although the present examples are primarily directed towards advertising, they are generally applicable to content delivered over a network in general, especially where the selection of content is not directly controlled by the content consumer. For example, a selection process for targeting a given consumer for an ad in an ad campaign and delivering said ad may be applicable to a content delivery service as well. In an example, a video streaming service may implement features of the present disclosure to determine a next video to show a connected user, for example, where the video streaming service is set to automatically generate a play list for the user. In an example, an ad may be substituted for a video as the content played. Certain video content may also be promoted to the front of a viewing queue, for example, based on historical consumption preferences of the viewer. In an example, a producer of the promoted content may target given users who have profiles that are likely matches for new viewers or subscribers. In an example, a content producer may bid on an advertising slot to place their content in front of a potential regular consumer. Similarly, in the advertising systems disclosed herein, content not generally associated with advertising (e.g., the video producer, weather alerts, government security alerts, surveys, etc.) may be delivered instead of a typical advertisement. In an example, an advertisement may be substituted with media content in general, and the advertisement delivery systems disclosed herein may be general media content delivery systems delivering primarily publisher content with limited interruptions in the form of advertisements.

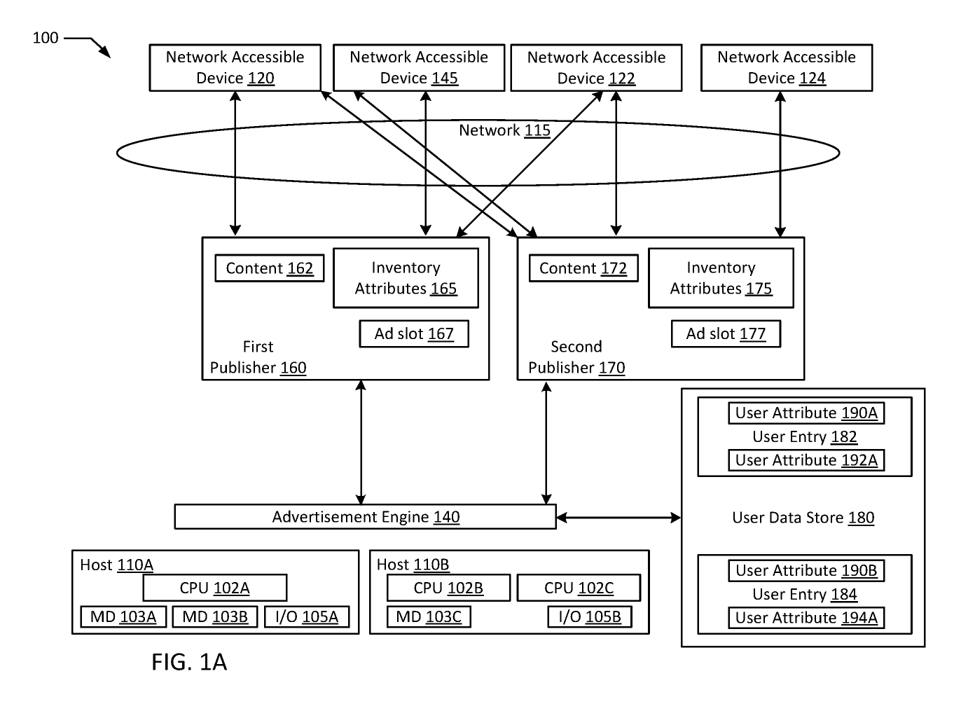

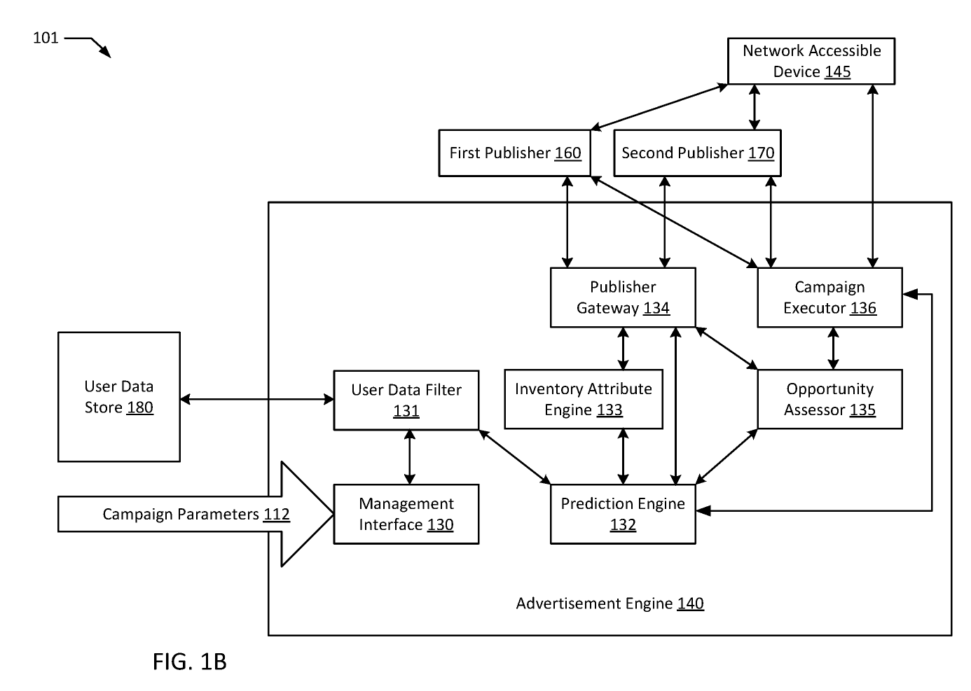

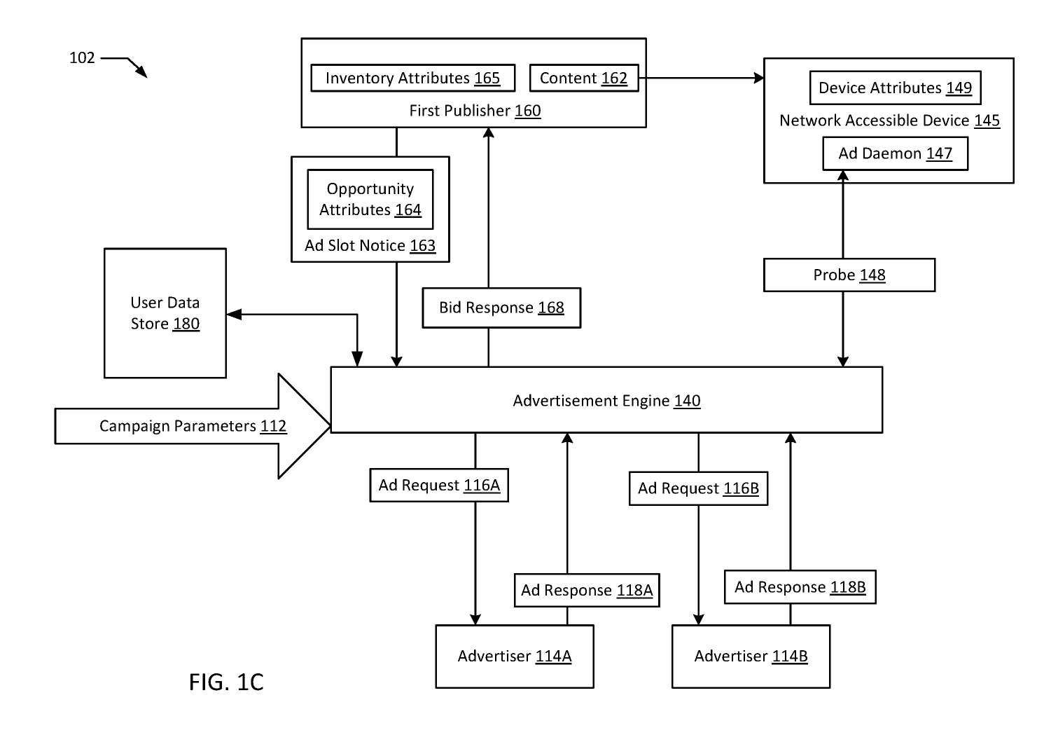

FIG. 1A is a block diagram of the delivery of advertisements in a system performing predictive analysis for controlling real-time advertising placements according to an example of the present disclosure. In an example, network accessible devices 120, 122, 124, and 145 may be any form of network connected device from classic endpoint computing terminals (e.g., desktop and laptop computers), to mobile devices (e.g., tablets, cellular phones, smart watches, smart glasses, head-up displays, virtual reality displays), to Internet of Things (“IoT”) endpoint devices which may include household appliances (e.g., smart TVs, washers, driers, refrigerators, dishwashers, ovens, vacuum cleaners etc.). In various examples network accessible devices 120, 122, 124, and 145 may have memory and one or more processors. As used herein, physical processor or processors (Central Processing Units “CPUs”) refer to devices capable of executing instructions encoding arithmetic, logical, and/or I/O operations. In one illustrative example, a processor may follow Von Neumann architectural model and may include an arithmetic logic unit (ALU), a control unit, and a plurality of registers. In an example, a processor may be a single core processor which is typically capable of executing one instruction at a time (or process a single pipeline of instructions), or a multi-core processor which may simultaneously execute multiple instructions. In another example, a processor may be implemented as a single integrated circuit, two or more integrated circuits, or may be a component of a multi-chip module (e.g., in which individual microprocessor dies are included in a single integrated circuit package and hence share a single socket). A processor may also be referred to as a central processing unit (CPU). As discussed herein, a memory device refers to a volatile or non-volatile memory device, such as RAM, ROM, EEPROM, or any other device capable of storing data.

In an example, network 115 may be any type of network, for example, a public network (e.g., the Internet), a private network (e.g., a local area network (LAN) or wide area network (WAN)), or a combination thereof. In an example devices connected through network 115 may be interconnected using a variety of techniques, ranging from a point-to-point processor interconnect, to a system area network, such as an Ethernet-based network. In an example, advertisement engine 140 may execute on any virtual or physical hardware connected to network 115. In an example, advertisement engine 140 executes on hosts 110A-B. The system 100 may include one or more interconnected hosts (e.g., hosts 110A-B). Each host 110A-B may in turn include one or more physical processors (e.g., CPU 102A-C) communicatively coupled to memory devices (e.g., MD 103A-C) and input/output devices (e.g., I/O 105A-B). As used herein, physical processor or processors (Central Processing Units “CPUs”) 102A-C refer to devices capable of executing instructions encoding arithmetic, logical, and/or I/O operations. In one illustrative example, a processor may follow Von Neumann architectural model and may include an arithmetic logic unit (ALU), a control unit, and a plurality of registers. In an example, a processor may be a single core processor which is typically capable of executing one instruction at a time (or process a single pipeline of instructions), or a multi-core processor which may simultaneously execute multiple instructions. In another example, a processor may be implemented as a single integrated circuit, two or more integrated circuits, or may be a component of a multi-chip module (e.g., in which individual microprocessor dies are included in a single integrated circuit package and hence share a single socket). A processor may also be referred to as a central processing unit (CPU).

As discussed herein, a memory device 103A-C refers to a volatile or non-volatile memory device, such as RAM, ROM, EEPROM, or any other device capable of storing data. As discussed herein, I/O device 105A-B refers to a device capable of providing an interface between one or more processor pins and an external device, the operation of which is based on the processor inputting and/or outputting binary data. CPUs 102A-C may be interconnected using a variety of techniques, ranging from a point-to-point processor interconnect, to a system area network, such as an Ethernet-based network. Local connections within each host 110A-B, including the connections between a processor 102A and a memory device 103A-B and between a processor 102A and an I/O device 105A may be provided by one or more local buses of suitable architecture, for example, peripheral component interconnect (PCI).

In computer systems (e.g., system 100), it may be advantageous to scale application deployments by using isolated guests such as virtual machines and containers that may be used for creating hosting environments for running application programs. Typically, isolated guests such as containers and virtual machines may be launched to provide extra compute capacity of a type that the isolated guest is designed to provide. Isolated guests allow a programmer to quickly scale the deployment of applications to the volume of traffic requesting the applications as well as isolate other parts of system 100 from potential harmful code executing within any one virtual machine. In an example, a VM may be a robust simulation of an actual physical computer system utilizing a hypervisor or a component (e.g., a virtual machine manager) that executes tasks commonly executed by hypervisors to allocate physical resources to the virtual machine. In an example, hosts 110A-B may be virtual machines executing on top of physical hosts, possibly with a hypervisor executing between the virtualized layer and the physical hosts. In another example, hosts 110A-B may be physical hosts, but certain component parts of hosts 110A-B may be hosted in isolated guests. In an example, advertisement engine 140 may be virtualized in a container or virtual machine.

In an example, advertisement engine 140 may be a dedicated component serving network accessible device 145, (e.g., a service executing in a dedicated isolated guest such as a VM or container), or advertisement engine 140 may be a generic component or service serving a large plurality of network accessible devices (e.g., network accessible devices 120, 122, 124, and 145). In the dedicated example, a plurality of advertisement engines may be communicatively coupled with each other, or may share common data storages. In an example, advertisement engine 140 may be connected with a user data store 180. In the example, user data store 180 may further include user entries 182 and 184, which may in turn contain user attributes 190A, 192A, 190B and 194A. In an example, user data store 180 may be stored in any suitable type of database, for example, a relational database. The user data store 180 may be stored in a database associated with a database management system (DBMS). A DBMS is a software application that facilitates interaction between the database and other components of the system 300. For example, a DMBS may have an associated data definition language describing commands that may be executed to interact with the database. Examples of suitable DMBS's include MariaDB®, PostgreSQL®, SQLite®, Microsoft SQL Server® available from MICROSOFT® CORPORATION, various DBMS's available from ORACLE® CORPORATION, various DBMS's available from SAP® AG, IBM® DB2®, available from the INTERNATIONAL BUSINESS MACHINES CORPORATION, etc. In an example, the user data store 180 may be stored in a database organized as a formal database with a schema such as a relational schema with defined tables, indices, links, triggers, various commands etc. In some examples, user data store 180 may not be organized as a formal database, but may instead be an alternative storage structure capable of holding the information stored in user data store 180, including but not limited to a file, folder, directory, registry, etc. In an example, user data store 180 is stored in non-volatile storage.

In an example, user data store 180 may be organized as records of individual users (e.g., user entries 182 and 184). For example, user attributes 190A and 192A may be user attributes of a user associated with user entry 182, while user attributes 190B and 194A may be user attributes of a user associated with user entry 184, including demographic identifying information. In the example, user attributes 190A, 192A, 190B and 194A may include various data points including at least one of a gender, an age, a race, a marital status, an income, a browsing history, a home ownership status, disabilities, a level of education, a employment status, an occupation, a status of having children, a location, a means of transportation, an amount of savings, a religion, and a contractual relationship. In various examples, user attributes 190A, 192A, 190B and 194A may be an individual user attribute or data point, and/or the combined records for a given user. In other examples, user attributes 190A, 192A, 190B and 194A may be specific demographic identifying user attribute categories (e.g., gender, age, race, marital status, income, browsing history, home ownership status, disabilities, level of education, employment status, occupation, status of having children, location, means of transportation, amount of savings, religion, contractual relationship, etc.). In the examples, user attributes 190A, 192A, 190B and 194A may be references to specific information under each demographic identifying user attribute category. In an example, advertisement engine 140 may query user data store 180 for candidates to receive an advertisement. In an example, a preliminary selection process for a target audience of an advertisement may be a query to user data store 180. In an example, user attributes 190A and 190B may be two copies of the same user attribute shared between users associated with user entry 182 and user entry 184 respectively. In another example, user attributes 190A and 190B may be alternative versions of the same user attribute category (e.g., male vs. female, or Asian vs. Caucasian). In an example, user data store 180, user entries 182 and 184, and user attributes 190A, 190B, 192A, and 194A may be populated based on data collected by a hypertext transfer protocol (“HTTP”) browser cookie. In another example, various users may consent to directly sharing user attributes 190A, 190B, 192A, and 194A with advertisement engine 140 in exchange, for example, for less total advertisements shown or better quality advertisements shown.

In an example, first publisher 160 and second publisher 170 may be publishers of content 162 and 172 respectively located across network 115 from advertisement engine 140. For example, first publisher 160 and/or second publisher 170 may provide business, political, financial, or sports news. In another example, first publisher 160 and/or second publisher 170 may provide a dedicated shopping interface, for example, one that provides discounts for stores in the immediate vicinity, or an application for a web retailer. In an example, first publisher 160 and second publisher 170 may be competitors. For example, first publisher 160 may be a website such as a search engine, while second publisher 170 may be a social media site. In another example, first publisher 160 may be an application on a smart phone or tablet dedicated to accessing first publisher 160 content 162. In an example, second publisher 170 may be a messaging service or gaming platform. In an example, each publisher (e.g., first publisher 160 and second publisher 170) will have a plurality of inventory attributes (e.g., inventory attributes 165 and 175). These inventory attributes 165 and 175 may be stored in databases or other suitable data structures associated with first publisher 160 and second publisher 170. In an example, an inventory attribute may be associated with the intermediary as a whole. For example, inventory attribute 165 may be statistics on the total number of hits first publisher 160 receives in a given time period, along with time of day trends etc. In another example, an inventory attribute 165 may be associated with a particular user (e.g., a user with user attribute 190A), where inventory attribute 165 may include information on a frequency and a pacing of the user's visits to first publisher 160. For example, inventory attribute 165 may indicate that the user visits first publisher 160 on average six times a month, including every Sunday, and on average accesses first publisher 160's content 162 long enough for seven advertisements to be shown per visit. In an example, each time a publisher's (e.g., first publisher 160 and second publisher 170) content (e.g., content 162 and 172 respectively) is accessed from network accessible device 145, at least one ad slot (e.g., ad slots 167 and 177) to present an advertisement may arise. In an example, inventory attribute 165 may be associated with an ad slot 167, for example, first publisher 160 may have collected data on the probability of a user viewing an article giving rise to ad slot 167 of continuing onto a second article and thus adding an additional potential impression to ad slot 167. In an example, inventory attributes may include cost, access rate of publisher by a user, identity of the publisher, identity of specific content of the publisher accessed by a user, frequency, and pacing of content access by a user. In an example, an advertisement engine 140 may interface with a plurality of publishers including first publisher 160 and second publisher 170.

In an example, first publisher 160 and/or second publisher 170 may respond to queries from advertisement engine 140 related to whether a given user accesses any content through a given publisher. In the example, advertisement engine 140 may target an advertisement at single males with sufficient income to afford a luxury car, living in a metropolitan area, who have recently purchased a high end watch. Various filters placed on user attributes (e.g., user attributes 190A, 190B, 192A, and 194A) in user data store 180 may produce a list of users who fit the above criteria demographically. Advertisement engine 140 may then query first publisher 160 and/or second publisher 170 regarding which users on the list are frequent visitors to each publisher's offerings. A list of network accessible devices (e.g., network accessible devices 120, 122, 124, and 145) associated with these users may be generated based on user attributes and/or inventory attributes mapping a user to a network accessible device (e.g., network accessible devices 120, 122, 124, and 145). A final list of network accessible devices that advertisement engine 140 may wish to target in a given advertising campaign may then be added to a list of network accessible devices. In an example, first publisher 160 and/or second publisher 170 may be requested to notify advertisement engine 140 whenever one of the queued network accessible devices accesses content through first publisher 160 and/or second publisher 170. In another example, advertisement engine 140 may pre-purchase advertising slots in any prospective ad slots related to the list of users (e.g., ad slots 167 and/or ad slot 177) that arise. In system 100 as illustrated in FIG. 1A, network accessible devices 120, 122, and 145 access content 162 through first publisher 160 and network accessible devices 120, 122, 124 and 145 all access content 172 through publisher 170.

FIG. 1B is a block diagram of an example system with an advertisement engine performing predictive analysis for controlling real-time advertising placements according to an example of the present disclosure. System 101 as illustrated in FIG. 1B shows an example advertisement engine 140, which includes multiple modules in communication with user data store 180, first publisher 160, second publisher 170, and network accessible device 145. For example, advertisement engine 140 may include a management interface 130, a user data filter 131, a prediction engine 132, an inventory attribute engine 133, a publisher gateway 134, an opportunity assessor 135, and a campaign executor 136.

In an example, for a given ad campaign, certain campaign parameters 112 may be determined by an advertising manager. These campaign parameters 112 (e.g., campaign duration, demographic, budget, target audience size, time of day, and publishers to use) may be received and updated by management interface 130. In an example, management interface 130 may provide a real-time prediction interface for showing the advertising manager predicted effects of modifying any one campaign parameter of campaign parameters 112 on the other campaign parameters of campaign parameters 112. For example, management interface 130 may output the predicted effects on cost or target audience size based on the time of day a given ad campaign.

In an example, user data filter 131 may provide an interface between advertisement engine 140 and user data store 180. In the example, when a set of campaign parameters 112 is received by management interface 130, user data filter 131 may first generate a list of users based on data in user data store 180 by, for example, filtering based on demographic criteria provided in campaign parameters 112. In an example, user data filter 131 operates on the entire contents of user data store 180 without representative sampling. In such an example, a list of users generated by user data filter 131 may be assured of conforming to a target demographic with a high degree of certainty. For example, where user data store 180 contains a million user entries (e.g., user entries 182 and 184), where 1,000 users are represented by a target demographic (e.g., Caucasian male 30-40 with kids living in a metropolitan area), a list of users generated by user data filter 131 may include each of the 1,000 target users.

In an example, publisher gateway 134 may be an interface between advertisement engine 140 and a plurality of publishers (e.g., first publisher 160 and second publisher 170). In the example, first publisher 160 and second publisher 170 may provide broad inventory attributes including metrics related to the demographic of a respective user base of each of first publisher 160 and second publisher 170. In an example, first publisher 160 may indicate that of one million unique monthly consumers of content 162, 0.1% match the target demographic (e.g., Caucasian male 30-40 with kids living in a metropolitan area). In an example, an ad campaign may be executed targeting the 0.1% of first publisher 160's users who match the target demographic. In such an example, each time any user accesses content, first publisher 160 may notify publisher gateway 134 of the opportunity, and opportunity assessor 135 may analyze whether any given user matches the demographic, In an example, publisher gateway 134 and inventory attribute engine 133 may also query first publisher 160 and second publisher 170 regarding inventory attributes specific to a particular user (e.g., for each of the users identified on the list generated by user data filter 131). In such an example, prediction engine 132 may pre-query first publisher 160 for inventory attributes for each selected user and predetermine targets whose opportunities would be immediately pursued by campaign executor 136. In contrast to a system where opportunity assessor 135 makes fresh determinations whether to pursue a given opportunity, in a system where a list of targets is predetermined by prediction engine 132, when one of the targets on the list of targets later accesses content 162 through first publisher 160, opportunity assessor 135 and/or campaign executor 136 may determine whether the opportunity originates from a target on the list significantly faster than looking up user attributes for a user without the pre-determination, thereby lowering response time for pursuing the opportunity.

An example prediction engine 132 may receive user attribute based input from user data filter 131 (e.g., in the form of a list of users fitting a target demographic), and enrich the list based on inventory attributes collected through inventory attribute engine 133. For example, of the 1,000 identified users, prediction engine 132 may determine that 500 users visited first publisher 160 on a weekly basis while 700 users visited second publisher 170 on a weekly basis, with 400 users overlapping. In the example, based on the previous usage data, prediction engine 132 may determine that targeting the 800 total users who visit either site on a weekly basis may likely yield 700 successful ad placements over the next week in a one week ad campaign. However, without a pre-identified list of users to query (e.g., the list generated by user data filter 131), a similar prediction made based on high level inventory attributes may be significantly less accurate. For example, the average content consumer of first publisher 160 may visit once every two weeks, and the average content consumer of the second publisher may visit once every three weeks. In an example, without user specific application of inventory attributes, it may be determined, based on the average visit rates to first publisher 160 and second publisher 170, that a one week ad campaign may only be expected to deliver 300 successful ad placements rather than 700. In the example, the ad manager may then elect to unnecessarily broaden the target demographic to reach a sufficient target audience size, but may end up needing to deliver significantly more ads to the wider demographic (e.g., Caucasian male 30-40 with or without kids living in a metropolitan area) for a similar number of increased sales targeting the wider demographic. In an example, by pre-determining an exact set of targets (e.g., based on user data filter 131), the quantity of ads that are delivered by advertisement engine 140 may be significantly reduced. In addition, with the addition of inventory attribute data from inventory attribute engine 133, prediction engine 132 may pre-determine specific circumstances under which to pursue a given ad slot or opportunity for a given user. In an example, by pre-determining usage characteristics of each selected user for an ad campaign, response times for pursuing a given ad opportunity received from first publisher 160 and/or second publisher 170 may be reduced, resulting in fewer lost opportunities based on response latency.

In an example, campaign executor 136 may deliver ads either directly to network accessible device 145 or through one of the publishers (e.g., first publisher 160 or second publisher 170). In an example, campaign executor 136 may deliver significantly less total ads based on prediction engine 132 integrating user entries with inventory attributes to accurately predict a number of ad placements necessary to yield a desired quantity of responses. For example, rather than delivering 1,400 ads to Caucasian males 30-40 with or without kids living in a metropolitan area, campaign executor 136 may deliver 700 ads to Caucasian male 30-40 with kids living in a metropolitan area. The reduction in ad placements may yield significant efficiencies in the form of reduced processing needs and reduced bandwidth needs for campaign executor 136. In an example, for a video advertisement, delivery to a network accessible device (e.g., network accessible device 145) may account for the vast majority of the network bandwidth used by advertisement engine 140. In the example, more accurate predictions for ad targets may allow more ad campaigns to be delivered from the same hardware by reducing the bandwidth requirements for campaign executor 136 and thereby advertisement engine 140 for delivering an ad campaign.

In addition, first publisher 160 and second publisher 170 may communicate opportunities for displaying an ad to opportunity assessor 135 (e.g., through publisher gateway 134). In an example, communicated opportunities may be individually assessed based on a user associated with the opportunity and inventory attributes for the user associated with the opportunity. In an example, opportunity assessor 135 may determine not to pursue a given opportunity due to the opportunity occurring during a bandwidth limited peak usage time of day. In the example, opportunity assessor 135 may make its determination based on prediction engine 132 having determined that the user may typically access content again during a low bandwidth usage period later in the week. In an example, campaign executer 136 delivering the advertisement during the bandwidth limited peak usage time of day may have resulted in a degradation in performance for other advertisements being delivered. In an example, prediction engine 132 may pre-determine usage characteristics of a given user based on combining inputs from user data filter 131 and inventory attribute engine 133 prior to campaign executor 136 executing an ad campaign. In the example, using the pre-determined usage characteristics for the given user, opportunity assessor 135 may determine whether to pursue a given opportunity with significantly less processing thereby moving processing from a latency and response time sensitive step to a step with significantly less latency restraints. For example, opportunity assessor 135 and campaign executor 136 may typically have between 500 ms and 1 s to determine whether to pursue a given opportunity to display an ad. Therefore, by prediction engine 132 preemptively producing usage characteristics, opportunity assessor 135 may perform a fast lookup of the usage characteristics rather than determining the usage characteristics in real-time potentially missing the opportunity due to a delayed response.

FIG. 1C is a block diagram of an example system where an advertisement engine performs predictive analysis and then verifying the results of the predictive analysis prior to committing to a real-time advertisement placement according to an example of the present disclosure. In an example, advertisement engine 140 is implemented by a primary advertiser (e.g., an advertiser, ad agency, ad exchange) executing an advertisement campaign to a targeted audience. In an example the prediction verification methods depicted in FIG. 1C may be implemented by a content distributor and/or publisher (e.g., publishers 160, 170) to select content, including advertisements) to a content consumer. In an example, an ad campaign is associated with a defined set of campaign parameters 112 input into advertisement engine 140. For example, an advertiser may intend to run an ad campaign for a new smart phone in the Chicago area targeting users of older versions of phones from the same manufacturer as well as those using phones of several key competitors. In an example, user data store 180 may include a plurality of user profiles which may include device type identifiers these users have used to access content from publishers 160 and 170. In an example, ad engine 140 may pre-generate filtered lists of users who have connected to publishers 160 and 170 from the Chicago area using one of the older generation smart phones identified in campaign parameters 112.

In an example, network accessible device 145 is connected to publisher 160 and is accessing content 162. In the example, publisher 160 gathers user and/or device specific inventory attributes associated with network accessible device 145 and incorporates these attributes into inventory attributes 165. For example, device attributes 149 of network accessible device 145 may include a variety of device and/or user identifying attributes, such as a hardware MAC address or IMEI serial number, device make and model, screen resolution, login accounts, social media accounts, GPS location, cellular location, WiFi status, etc. In an example, inventory attributes 165 may additionally include identifying features of network accessible device 145 and its user such as access rate of publisher by the user, identity of specific content of the publisher accessed by a user, frequency, and pacing of content access by the user. In an example, content 162 includes an ad slot that becomes an ad opportunity when network accessible device 145 loads the portion of content associated with the ad slot. In the example, publisher 160 generates ad slot notice 163 indicating an ad opportunity is available on network accessible device 145, and sends this ad notice 163 to ad engine 140. In the example, ad slot notice 163 includes opportunity attributes 164 which are inventory, device, and/or user attributes associated with network accessible device 145. In the example, opportunity attributes 164 may provide advertisement 140 with the only information regarding an identity or demographic of a user consuming content 162 (e.g., the current user of network accessible device 145) for ad targeting purposes. In some instances opportunity attributes 164 may include highly probative information such as a MAC address. In other examples, opportunity attributes 164 may only include very generic information such as a screen resolution and a content type of content 162.

In an example, prior to bidding on the ad opportunity of ad slot notice 163, ad engine 140 queries the pre-targeted campaign user lists of user data store 180 to attempt to match ad slot notice 163, and therefore network accessible device 145, to a user profile in user data store 180. In the smartphone ad campaign example, if opportunity attributes 164 lack attributes identifying a current location and device type of network accessible device 145, opportunity attributes 164 may nevertheless include sufficient attributes to obtain a high probability match with a user profile (e.g., user entry 182, 184) of user data store 180. For example, a username of an account with publisher 160 may be an attribute included as one of opportunity attributes 164. The username may be associated with a user profile in user data store 180, either as a username with publisher 160, or as a username with a different publisher (e.g., publisher 170). In an example, even if opportunity attributes 164 lack the Chicago location and the device type of a targeted device based on campaign parameters 112, if the associated user profile matched in user data store 180 does identify ad slot notice 163 as being potentially associated with a Chicagoan who previously connected with an older phone by the manufacture executing the ad campaign, advertisement engine 140 may determine that ad slot notice 163 is worth bidding on. In an example, matching a username is an imperfect match because different people may register the same username on different systems (e.g., publishers 160 and 170). In an example, even fairly probative opportunity attributes (e.g., MAC address) may not yield accurate user profiles. For example, a MAC address associated with a user profile of a male professional between 30 and 40 may be accessing a kids cartoon based on opportunity attributes 164. In the example, bid response 168 may be valued based on a confidence of the likelihood that a user of network accessible device 145 belongs to the targeted demographic of campaign parameters 112. In an example, bid response 168 is a winning bid entered based on a username for publisher 160 included in opportunity attributes 164 matched a username in user data store 180 associated with publisher 170. In an example, publisher 160 sends connection information for network accessible device 145 to ad engine 140 in response to the winning bid in bid response 168.

In an example, after sending bid response 168, for example, upon receiving confirmation of the successful bid, ad engine 140 may send out ad requests 116A-B to advertisers 114A-B. In the example, ad requests 116A-B are requests for advertisers 114A-B to bid on the ad opportunity on network accessible device 145 in ad slot notice 163. In an example, immediately before, immediately after, or substantially simultaneously with sending ad requests 116A-B, ad engine 140 sends probe 148 to network accessible device 145. In the example, probe 148 includes a query for device and/or user attributes from network accessible device 145 to verify that a current user of network accessible device 145 is an acceptable target for the smartphone ad based on campaign parameters 112. In an example, probe 148 may include an ad daemon 147 that executes on network accessible device 145 to gather device attributes 149.

In an example, an ad daemon 147 may be deployed on network accessible device 145. The ad daemon 147 may be installed as part of an application (e.g., shopping application, browser, etc.) executing on network accessible device 145. In another example, ad daemon 147 may be included as part of the ad content of advertisement 110, or part of an initial handshake between advertisement engine 140 and network accessible device 145 to establish a network session for delivering network content. In an example, ad daemon 147 may be implemented in any suitable programming language (e.g., Java, C, C++, C-sharp, Visual Basic, structured query language (SQL), Pascal, common business oriented language (COBOL), business process execution language (BPEL), business process model notation (BPMN), complex event processing (CEP), jBPM, Drools, etc.). In an example, ad daemon 147 may be embeded in web content retrieved by network accessible device 145, for example, ad daemon 147 may be implemented with HTML5 or JavaScript executing in a browser on network accessible device 145. In another example, ad daemon 147 may be included in probe 148 and may execute on network accessible device 145 after probe 320 is received. For example, probe 148 may be an HTML5 or JavaScript script loaded with publisher web content that includes ad daemon 147 as a module that executes in the background while advertisement engine 140 maintains an open network connection with network accessible device 145.

In an example, ad daemon 147 collects information on device attributes 149 on network accessible device 145, for example, physical characteristics of network accessible device 145 (e.g., make, model, hardware components, screen size, form factor, etc.), virtual attributes (e.g., network address, device identifiers, account names, open browsing sessions, gps location, cellular location, phone number, etc.) and communicates a report of device attributes 149 to advertisement engine 140. In an example, ad daemon 147 summarizes the data collected and communicates the summaries with advertisement engine 140. In an example, ad daemon 147 periodically probes for updates to device attributes 149, for example, multiple times per second during an advertising or content delivery exchange. In an example, ad daemon 147 may set a repeating timer to poll an attribute (e.g., 2, 3, 4, 5, . . . 10 times per second).

In an example, probe 148 verifies that the user of network accessible device 145 is the same as the user with the matching username registered with publisher 170, for example, based on a phone number of network accessible device 145. In another example, probe 148 determines that network accessible device 145 does not belong to the user who's profile matched, for example, based on a logged in social media account. In either example, such verification is not dispositive regarding whether the smartphone ad is sent to network accessible device 145. For example, in the case where the user name match was accurate, one of device attributes 149 may identify that network accessible device 145 is the same model smartphone as the one being advertised in the ad campaign of campaign parameters 112, and therefore the ad should not be sent. In the example where the user name match was inaccurate, device attributes 149 may include GPS location data in the Chicago area, and that network accessible device 145 is one of the targeted devices for the ad campaign, and therefore the smartphone ad should be sent. In the kids cartoon example, a child lock setting may be active indicating that network accessible device 145 is currently being used to entertain a child. Alternatively, the cartoon may be playing from a link from a web search for buying toys associated with the cartoon characters, indicating that the user was correctly identified and may be researching a gift for his kids (e.g., he may be receptive to shopping for himself as well).

In an example, if ad engine 140 determines, based on probe 148, that a current user of network accessible device 145 is a target for the smartphone ad campaign, the smartphone ad is sent to network accessible device 145. In an example, the ad may be routed through publisher 160. In another example, ad engine 140 sends the ad directly to network accessible device 145. In such examples, advertiser 114A's ad response 118A sends a bid to show an ad for a New York City musical based on the New York City GPS location of network accessible device 145, and advertiser 114B's ad response 118B sends a low bid as part of an ad campaign by an internet service provider that has recently rebranded itself as part of a corporate reorganization. In the example, the internet service provider aims to reach a maximum audience (e.g., to spread the notoriety of new trademarks) for a minimum campaign cost and therefore bids on opportunities passed on by other advertisers. In an example, ad engine 140 solicits bids from advertisers 114A-B to have an alternative advertisement ready in case ad engine 140 determines to cancel sending an ad to network accessible device 145 in the event that probe 148's results indicate that network accessible device 145's current user is not a target of the ad campaign of campaign parameters 112. If ad engine 140 determines that it will send an ad to network accessible device 145, either based on probe 148 verifying that network accessible device 145 is a target for the ad campaign of campaign parameters 112, or where probe 148 determines that there is an alternative ad campaign for whom the user of network accessible device 145 is a target, then ad engine 140 may cancel its auction to secondary advertisers 114A-B for an alternative advertisement to display. In an example, ad engine 140 may simply ignore ad responses 118A-B, for example, where advertisers 114A-B are not aware of each other and/or other bidders on the ad slot. In such examples, advertisers 114A-B may determine that they have failed to enter a winning bid.

In an example, ad engine 140 determines, for example, based on probe 148, to cancel sending the smartphone ad to network accessible device 145. In such an example, ad response 118A and/or 118B may typically be received by network accessible device 145 before results are returned from probe 148, or ad responses 118A-B may at least be expected to be received within 100 ms of receiving a response to probe 148. In the example, ad engine 140 notifies a winning bidder between advertisers 114A-B and sends the winning ad to network accessible device 145 in lieu of the smartphone ad. For example, advertiser 114A's bid for the musical tickets is a targeted advertisement resulting in a higher bid than advertiser 114B's internet service provider advertisement that is broadly targeted. In the example, the secondary advertisement for musical tickets from secondary advertiser 114A is displayed on network accessible device 145. In an example, ad engine 140 may identify that a user of network accessible device 145 matches a target demographic of a different ad campaign and may substituted the ad of that ad campaign in lieu of the smartphone ad. In an example, the substitution of the smartphone ad with another ad is undetectable by publisher 160 and network accessible device 145.

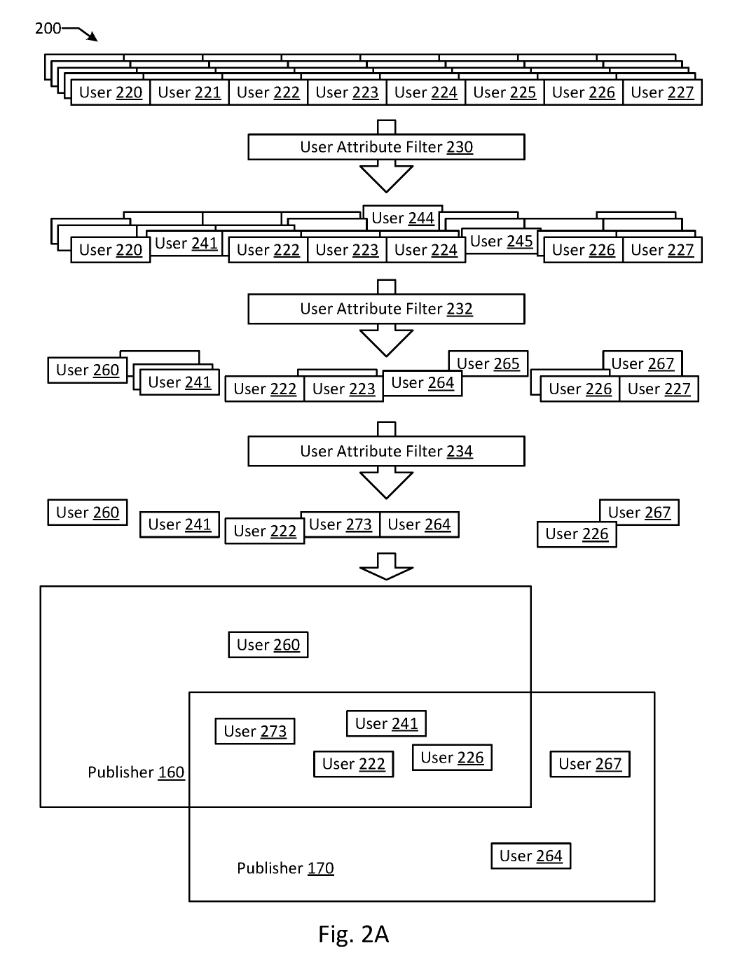

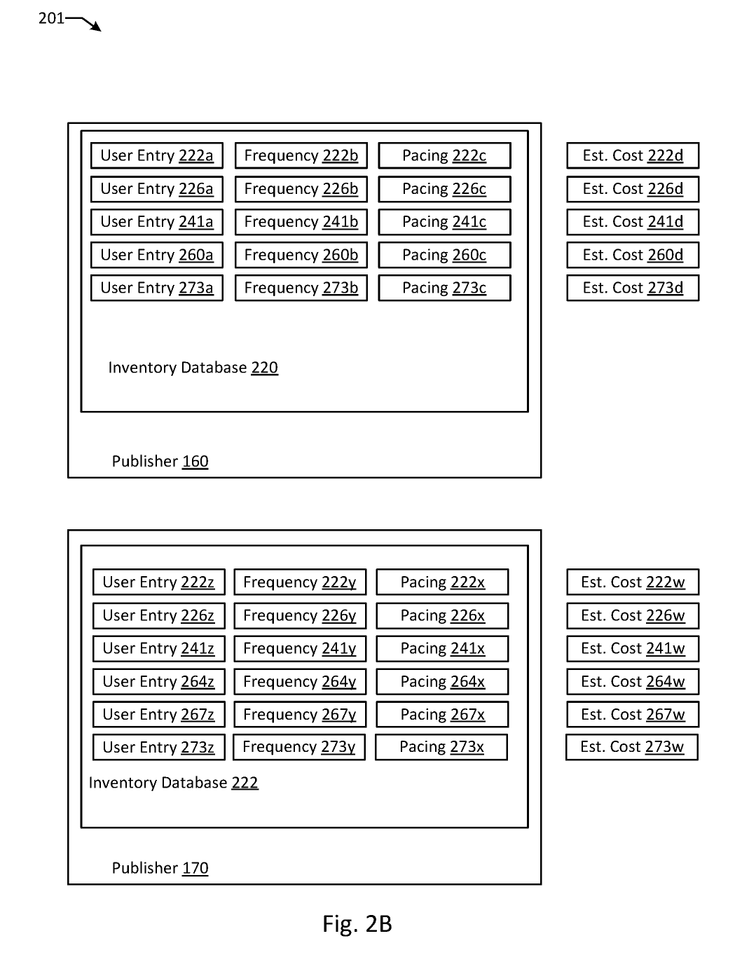

FIG. 2A is a block diagram of user selection in a system performing predictive analysis for controlling real-time advertising placements according to an example of the present disclosure. System 200 as illustrated in FIG. 2A shows a plurality of users (e.g., users 220-227) represented in user data store 180. In an example, an advertiser may want to show an advertisement for designer women's shoes, and may target female office workers, age 25-45, living in metropolitan areas. In the example, the block of users depicted as users 220-227 may represent all of the users advertisement engine 140 has user attribute information on through user data store 180 (e.g., via user data filter 131). In the example, user attribute filter 230 may be a filter for gender, filtering out all non-females. As a result, roughly half of the user base is filtered away, leaving the block of users represented by users 220, 222, 223, 224, 226, 227, 241, 244 and 245. In an example, user attribute filter 232 may be a further age filter, removing all users not in the targeted 25-45 demographic, resulting in the block of users labeled as users 222, 223, 226, 227, 241, 260, 265, and 267. A third user attribute filter 234 may then be used to filter on location (e.g., on zip code, IP address, GPS location etc.). After the third user attribute filter 234 is applied by user data filter 131, a very refined subset of users (e.g., users 222, 226, 241, 260, 264, 267, and 273) remains. These remaining users (e.g., users 222, 226, 241, 260, 264, 267, and 273) may then comprise a preliminary list of targets to receive the ad. Advertisement engine 240 may then query first publisher 160 and second publisher 170 to discover which of the preliminary list of users access content (e.g., contents 162 and 172) through each respective publisher. In an example, users 222, 226, 241, and 273 have historically accessed both publishers (e.g., first publisher 160 and second publisher 170), while user 260 has only accessed publisher 160 and users 264 and 267 have only accessed publisher 170. In an example, advertisement engine 240 may communicate with and advertise through many publishers. In an example, advertisement engine 240 may have special contractual relationships with first publisher 160 and second publisher 170 granting first publisher 160 and second publisher 170 preferential treatment for an advertising campaign for a particular advertisement.

FIG. 2B is a block diagram of publisher selection in a system performing predictive analysis for controlling real-time advertising placements according to an example of the present disclosure. System 201 as illustrated in FIG. 2B depicts inventory databases (e.g., inventory databases 220 and 222) associated with first publisher 160 and second publisher 170, where inventory databases 220 and 222 store inventory attributes of each user that accesses content through the publisher. For example, first publisher 160 may be associated with inventory database 220, in which may be entries for each of users 222, 226, 241, 260, and 273 (e.g., user entries 222a, 226a, 241a, 260a, and 273a). In the example each user entry (e.g., user entries 222a, 226a, 241a, 260a, and 273a) may be associated with a respective frequency (e.g., frequencies 222b, 226b, 241b, 260b, and 273b), and pacing (e.g., pacings 222c, 226c, 241c, 260c, and 273c) of each respective user's access habits to content 162 through publisher 160. For example, user entry 222a may be a user entry for user 222, indicating that user 222 accesses content 162 at least once a day (e.g., frequency 222b) and that each access typically results in an average of 3 opportunities to show advertisements (e.g., pacing 222c). In an example, frequency 222b and pacing 222c may be factors in calculating an estimated cost 222d for securing one of the likely 21 or more opportunities to show user 222 the designer shoe ad through first publisher 160 over the next week. Similar calculations may be made for each of users 226, 241, 260, and 273 (e.g., resulting in estimated costs 226d, 241d, 260d, and 273d).

In an example, second publisher 170 may maintain an inventory database 222 similar to first publisher 160's inventory database 220. In the example, users 222, 226, 241, 264, 267, and 273 may be associated with user entries 222z, 226z, 241z, 264z, 267z, and 273z, frequencies 222y, 226y, 241y, 264y, 267y, and 273y, pacings 222x, 226x, 241x, 264x, 267x, and 273x, and estimated costs 222w, 226w, 241w, 264w, 267w, and 273w. In an example, user 222 may access content 172 from publisher 170 for long enough to average 30 or more opportunities per week, but all of the accesses may be on Saturday afternoon as shown by frequency 222y and pacing 222x. In an example, advertisement engine 140 (e.g., through opportunity assessor 135 and campaign executor 136) may determine whether sending an ad to user 222 through publisher 160 or publisher 170 is likely to be more efficient, effective, and/or economical. For example, historical data may show that women like user 222 are more likely to impulse buy designer shoes online from work, favoring publisher 160's access pattern. Alternatively, historical data may show that most shoe sales occur on weekends after being tried in a retail store, favoring publisher 170's access pattern. In an example, advertisement engine 140 may be running an ad campaign starting Sunday for a Wednesday sale. In such an example, user 222's access pattern of content 172 may indicate that user 222 would not see the ad through publisher 170 at all before it was too late to be of use. In an example, advertisement engine 140 may not only filter for which advertisements are sent to which users, but also curate for customized advertisements for a particular user. For example, user 222 may subscribe to a third publisher which is a shopping application that suggests good deals, and advertisement engine 140 may curate an inventory of advertisements based on user attributes of user 222 to create a customized advertising experience whenever user 222 accesses the shopping application. In an example, inventory attribute engine 133 may request inventory attributes at a certain granularity. For example, on a weekly granularity, access patterns of publishers 160 and 170 may be relatively indistinguishable, but aggregated data may be transmitted faster.

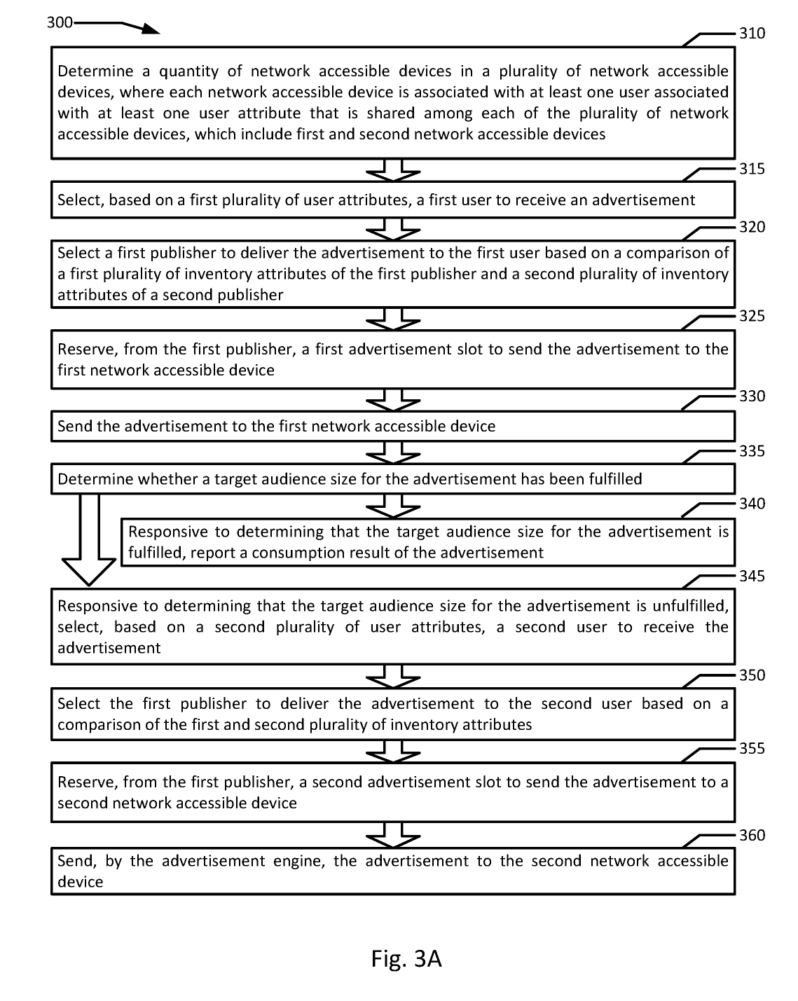

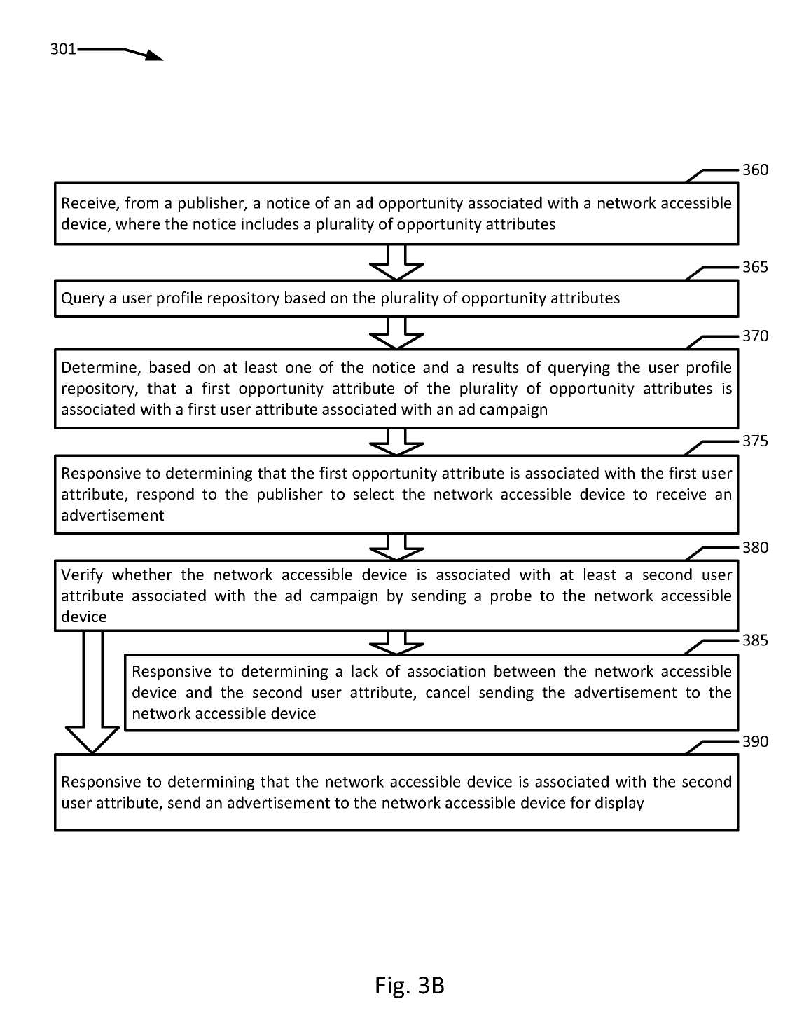

FIG. 3A is a flowchart illustrating an example of performing predictive analysis for controlling real-time advertising placements according to an example of the present disclosure. Although the example method 300 is described with reference to the flowchart illustrated in FIG. 3A, it will be appreciated that many other methods of performing the acts associated with the method 300 may be used. For example, the order of some of the blocks may be changed, certain blocks may be combined with other blocks, and some of the blocks described are optional. The method 300 may be performed by processing logic that may comprise hardware (circuitry, dedicated logic, etc.), software, or a combination of both. In an example, the method is performed by an advertisement engine 140.

A quantity of network accessible devices in a plurality of network accessible devices is determined, where each network accessible device of the plurality of network accessible devices is associated with at least one user associated with at least one user attribute that is shared among each of the plurality of network accessible devices, which includes at least a first network accessible device and a second network accessible device (block 310). In an example, a plurality of network accessible devices (e.g., network accessible devices 120, 122, 124 and 145) includes network accessible device 145 and network accessible device 120. In the example, each of network accessible devices 120, 122, 124, and 145 is associated with at least one user, including a user of network accessible device 145 and a user of network accessible device 120. In an example, the user of network accessible device 145 may be associated with a plurality of user attributes (e.g., user entry 182 in user data store 180 may be associated with the user of network accessible device 145, and user attributes 190A and 192A may be user attributes of the user of network accessible device 145). In the example, the user of network accessible device 120 may be associated with a plurality of user attributes (e.g., user entry 184 in user data store 180 may be associated with the user of network accessible device 120, and user attributes 190B and 194A may be user attributes of the user of network accessible device 120). In an example, advertisement engine 140 may be in communication with first publisher 160 (e.g., through publisher gateway 134), which is associated with inventory attributes 165, and also with second publisher 170, which is associated with inventory attributes 175. In an example, user data filter 131 determines that user attribute 190A and user attribute 190B are the same user attribute, and includes both network accessible device 145 and network accessible device 120 in a plurality of targeted network accessible devices. In another example, a third network accessible device (e.g., network accessible device 122 or 124) may be associated with a user with a third copy of the same user attribute, and may therefore be included in the plurality of targeted network accessible devices. However, in the example, it may be found that users associated with network accessible devices 145 and 120 may share a different user attribute not shared by users of network accessible devices 122 or 124 (e.g., the users of network accessible devices 145 and 120 may be Caucasian while the users of network accessible devices 122 and 124 may be Asian). In such an example, network accessible devices 122 and 124 may again be excluded from the plurality of targeted network accessible devices.

A first user is selected to receive an advertisement based on a first plurality of user attributes (block 315). For example, a user of network accessible device 145 is associated with user entry 182, including user attributes 190A and 192A. In an example, user attribute 190A indicates that the associated user is a woman, while user attribute 192A may be marital status indicating that the user is married. In an example, user attributes 190A and 192A are the basis for user data filter 131 determining that the user associated with user entry 182 should receive a given advertisement. In an example, user attributes 190A and 192A include at least one attribute of a gender, an age, a race, a marital status, an income, a browsing history, a home ownership status, disabilities, a level of education, a employment status, an occupation, a status of dependents, a head of household status, a location, a means of transportation, an amount of savings, a religion, and a contractual relationship. In an example, user attributes 190A and 192A may be collected by a browser cookie (e.g., an HTTP cookie) associated with the user of network accessible device 145, either from network accessible device 145 (e.g., a smart phone) or another network accessible device associated with the same user (e.g., a desktop computer).

A first publisher is selected to deliver the advertisement to the first user based on a comparison of a first plurality of inventory attributes of the first publisher and a second plurality of inventory attributes of a second publisher (block 320). In an example, inventory attributes 165 and inventory attributes 175 are compared by inventory attribute engine 133 in relation to a user of network accessible device 145. In an example, inventory attributes 165 include attributes specific to each of a plurality of users who consume content 162. In an example, the first publisher 160 may be selected to deliver the ad to the user for a combination of reasons, including those related to a cost of the ad slot 167, a cost of ad slot 177, a frequency of interaction between the user and publisher 160, a frequency of interaction between the user and publisher 170, a pacing of interactions between the user and publisher 160, a pacing of interactions between the user and the publisher 170. For example, network accessible device 145 may access the first publisher 160 for entertainment news regularly throughout the year, and second publisher 170 for fantasy football during football season, with more total yearly views going to second publisher 170. In the example, if the user does not access any non-football related content from publisher 170, and it is not currently football season, sending the advertisement to second publisher 170 would be unlikely to result in a successful placement to the user. In another example, the user may access content 162 through first publisher 160 daily to the tune of an average of five advertisements being shown a day, while accessing second publisher 170's content 172 twice a week but averaging fifteen advertisements shown per session. In the example, during a one week ad campaign, it may be determined that the odds of reaching the user through either publisher are roughly equal. However, in an example, a typical user navigates away from content after the third advertisement is shown, and therefore prices for the first three ad impression opportunities may be significantly higher. In the example, second publisher 170 may be a significantly more economical choice since the user's tenth, twelfth or fifteenth ad during a session may be significantly cheaper for opportunity assessor 135 and campaign executor 136 to place than one of the first five ad impressions. In an example, a variety of inventory attributes may be computed into a weighted score for each publisher, and the weighted scores may be compared to select a publisher for the advertisement. In an example, certain inventory attributes may be prioritized in calculating a weighted score (e.g., cost or likelihood of successful placement). In an example, at least one of: (i) a cost per advertisement, (ii) a probability of reaching a specific user, (iii) a relationship between the first publisher and a content of the advertisement, (iv) a length of time necessary to reach a specific user, and (v) a quantity of network accessible devices of the second plurality of network accessible devices that regularly interface with the first publisher, may be prioritized in calculating a weighted score.

A first advertisement slot is reserved from the first publisher to send the advertisement to the first network accessible device (block 325). In an example, ad slot 167 may be reserved by campaign executor 136 to send an ad to network device 145. In an example, a reservation may include a request to utilize pre-purchased advertising capacity with publisher 160. In another example, reserving ad slot 167 may require winning an auction for ad slot 167 against competitors of ad engine 140. In an example, a degree to which user attributes (e.g., user attributes 190A and 192A) of the user of network accessible device 145 matches a target demographic of the advertisement may influence campaign executor 136's bid for ad slot 167. In an example, a very specific match as a target recipient may allow campaign executor 136 to place a bid significantly above market rates to ensure the placement of the ad with the user. In an example, advertisement engine 140 may be affiliated with a particular publisher and may reserve an ad slot from that publisher without direct payments being made. In the example, placements with an affiliated publisher may be more efficient from a networking and bandwidth perspective and be preferential to those with unaffiliated publishers. The advertisement is sent to the first network accessible device (block 330). In an example, the advertisement is sent by campaign executor 136 to the network accessible device 145. For example, content 162 may embed a link to the advertisement allowing campaign executor 136 to serve the advertisement to network accessible device 145 directly. In another example, the advertisement may be first loaded to first publisher 160 and distributed in conjunction with content 162.

A determination is made whether a target audience size for the advertisement has been fulfilled (block 335). In an example, an advertising campaign including the advertisement distributed to network accessible device 145 may include a target audience size. In an example, the target audience size of the advertisement campaign may be based on a list of target users produced by user data filter 131 filtering user data store 180 based on demographic and/or purchase history criteria. In an example, a goal may be set to present the ad to 80% of the users in the list. In an example, list of target users may be compared with inventory attributes (e.g., inventory attributes 165 and 175) from a plurality of publishers (e.g., publishers 160 and 170) to determine a probability of reaching each user on the list through each publisher both from an availability of opportunities stand point (e.g., how likely an opportunity to present the advertisement will occur during the time frame of the ad campaign) as well as from a cost perspective (e.g., how much securing each opportunity that does occur may cost based on how rare the opportunities may be). In an example, an initial goal may be set to reach 80% of the users on the list, but it may later be determined that only 75% of the users on the list are likely to access any of the publishers (e.g., publishers 160 and 170) before the advertisement is no longer timely. In such a case, the target may require revision (e.g., to 70% of users listed) to establish a realistic goal. In an example, audience size setting may be performed in conjunction with the filtering of users, for example, certain filters may be modified or removed to adjust the target audience size to a desired size. For example, a filter for Caucasian users may be modified to also include Asian users. In an example, an advertising campaign may have an associated advertising budget.

In such an example, consideration may be given to maximize different factors of a plurality of factors indicative of successful outreach. On the one hand, emphasis may be placed on maximizing purchases per ad placement, and a very select list of users may be identified, user specific customizations may be made to a version of an advertisement to be played to each user, and the first opportunity to show an ad in each user's next session with the publisher (e.g., publishers 160 and 170) may be aggressively pursued. Advertising based on real-time audience therefore allows specifically generated bespoke ads to be tailored to each user in the list of user's, maximizing the odds that an ad would be well received. On the other hand, emphasis may be placed on reaching the largest audience for a given budget (e.g., where a new brand wants to build broad name recognition while not necessarily worried about ad placement to purchase ratio). In an example, loose user attribute filters may be used to generate a large target list of users. In the example, opportunity assessor 135 and campaign executor 136 may then target placements and opportunities towards the end of each user's expected session with each publisher, risking losing an opportunity to show an advertisement in exchange for cheaper placements. For example, if a user views five ads on average during a session, campaign executor 136 may bid in advance for the sixth or seventh ad slot for a given session, which may be significantly cheaper due to uncertainty that the user would see such an ad. Such a strategy may be advantageous for building up brand name recognition, reaching more total users for the same budget. In an example, a target audience size of the advertisement for the first publisher 160 may be calculated by prediction engine 132 calculating a probability of successfully reserving advertisement slots from the first publisher 160 to send the advertisement to each network accessible device (e.g., network accessible devices 120, 122, 124, and 145) of the plurality of network accessible devices based on the advertising budget.

In response to determining that the target audience size for the advertisement is fulfilled, report a consumption result of the advertisement (block 340). In an example, if the user of network accessible device 145 receiving the advertisement fulfills the calculated target audience size of the advertisement, advertisement engine 140 (e.g., through campaign executor 136) may then compile and report on consumption results of the advertisement. In an example, the consumption results of the advertisement are reported to an advertiser, an advertisement agency, and/or the first publisher 160. In an example, the consumption results may be based on feedback from network accessible devices that displayed the advertisement (e.g., network accessible device 145). For example, network accessible device 145 may report to campaign executor 136 a proportion of the advertisement that was consumed by the user of network accessible device 145, while a different network accessible device may report the proportion of the advertisement consumed by a respective user of the different network accessible device. In an example, the proportion consumed is based on a duration the advertisement was viewed, a duration of the advertisement that was successfully transmitted, and/or a subsequent action (e.g., click through, purchase, enrollment, or completed survey) taken by the first user in response to the advertisement. In an example, where sufficient budget is remaining, additional ad slots may be reserved to show the advertisement to more users or to show the advertisement to a previous viewer again (e.g., the user of network accessible device 145). In an example, a predetermined time period has elapsed between a first time when network accessible device 145 received the advertisement second time when another opportunity to show the advertisement on network accessible device 145 becomes available. In the example, in response to determining that the predetermined time period has elapsed, the campaign executor 136 reserves the new opportunity to send the advertisement to network accessible device 145 and sends the advertisement to network accessible device 145. For example, campaign executor 136 may be configured to limit each user to one view of the advertisement per day.

In response to determining that the target audience size for the advertisement is unfulfilled, select, based on a second plurality of user attributes, a second user to receive the advertisement (block 345). In an example, network accessible device 145 receiving the advertisement does not fulfill the target audience size of the advertisement. In the example, a user of network accessible device 120 with user attribute 190B which is the same as user attribute 190A may be selected as a recipient for the advertisement. In an example, the first publisher is selected to deliver the advertisement to the second user based on a comparison of the first plurality of inventory attributes and the second plurality of inventory attributes (block 350). In an example, for similar reasons to those provided for the selection of first publisher 160 to display the advertisement to network accessible device 145 rather than second publisher 170, including a comparison of inventory attributes 165 and 175 especially in relation to network accessible device 120, the advertisement engine 140 selects publisher 160 to deliver the advertisement to the user of network accessible device 120. A second advertisement slot is then reserved from the first publisher to send the advertisement to the second network accessible device (block 355). For example, an advertisement slot may be an opportunity for an advertisement impression during network accessible device 120's consumption of content 162 that is reserved by advertisement engine 140 to display the advertisement to the user of network accessible device 120. In an example, after securing the advertisement slot, the advertisement engine sends the advertisement to the second network accessible device (block 360). For example, advertisement engine 140 either directly or indirectly sends the advertisement to be displayed on network accessible device 120.

In an example, the advertisement engine 140 may select network accessible device 122 to also receive the advertisement. In the example, advertisement engine 140 may determine, that a user of network accessible device 122 is a Caucasian woman in her 30 s loosely matching the demographics of the users of network accessible devices 120 and 145. In an example, advertisement engine 140 bids on an advertisement slot made available by either the first publisher 160 or the second publisher 170 but fails to enter a winning bid. In the example, the advertisement engine 140 may factor in the frequency and/or pacing of the user of network accessible device 122's previous interactions with first publisher 160 and/or second publisher 170 in determining an amount to bid on the advertisement slot. For example, where network accessible device 122 historically loads an average of five advertisements during a session viewing first publisher 160's content 162, advertisement engine 140 may attempt to bid an amount calculated to win the fifth opportunity or impression of network accessible device 122's session, which may be significantly lower than the winning bid for the first impression or opportunity of the session. In an example, the same losing bid or even a lower bid may win on a subsequent impression or opportunity during the same session or in a new session after advertisements for higher bids have already been shown.

FIG. 3B is a flowchart illustrating an example of performing predictive analysis for controlling real-time advertising placements and verifying the results of the predictive analysis prior to committing to a real-time advertisement placement according to an example of the present disclosure. Although the example method 301 is described with reference to the flowchart illustrated in FIG. 3B, it will be appreciated that many other methods of performing the acts associated with the method 301 may be used. For example, the order of some of the blocks may be changed, certain blocks may be combined with other blocks, and some of the blocks described are optional. The method 301 may be performed by processing logic that may comprise hardware (circuitry, dedicated logic, etc.), software, or a combination of both. In an example, the method is performed by an advertisement engine 140.

In an example, method 301 may begin with receiving a notice of an ad opportunity associated with a network accessible device, where the notice includes a plurality of opportunity attributes (block 360). In an example, ad engine 140 receives ad slot notice 163 from publisher 160 which includes opportunity attributes 164. In an example, at least one opportunity attribute provided in opportunity attributes 164 is inaccurate. For example, network accessible device 145 may be indicated to be in the landscape view when it is in fact in the portrait view. In an example, a user residence opportunity attribute 164 identifies that network accessible device 145 is a New York City device based on a current GPS location. For example, lacking any address information on the user, publisher 160 attributes the user by default to the user's current location which in this case is erroneous. In an example, another opportunity attribute provided in opportunity attributes 164 is a phone number of network accessible device 145 indicating a Chicago area code. In an example, the New York City identification may be inaccurate (e.g., the user is traveling), and ad engine 140 may correct the location attribute before making a determination whether to bid on the ad slot. For example, the Chicago phone number may match a targeted user profile from user data store 180. In an example, the user profile in user data store 180 may include a billing address in a Chicago suburb for the user.

A user profile repository is queried based on the plurality of opportunity attributes (block 365). In an example, ad engine 140 queries user data store 180 with a plurality of opportunity attributes 164 to determine if ad slot notice 163 is associated with a user profile targeted in any current ad campaign. In an example, a query based on opportunity attributes 164 to user data store 180 may be structured as disclosed herein. For example, predetermined lists of user profiles associated with active ad campaigns may be queried rather than the whole database of user data store 180. In an example, rather than querying the entirety of user data store 180, a cached subset of entries (e.g., associated with a particular ad campaign) may be queried. In an example, certain opportunity attributes may be prioritized over others for structuring a query. For example, in the smartphone ad example, device type, location data, and area code may be priority query fields.

A first opportunity attribute of the plurality of opportunity attributes is determined to be associated with a first user attribute associated with an ad campaign based on the notice and/or a results of querying the user profile repository (block 370). In the example, campaign parameters 112 indicate that a smartphone ad campaign is targeting owners of certain models of phones in the Chicago area. In the example, a phone number opportunity attribute of opportunity attributes 164 may be associated with Chicago based on area code. In the example, a username opportunity attribute may be associated with a user profile in user data store 180, and the profile may indicate that the associated with a Chicago address. In an example, a determination that the user whose content access generated ad slot notice 163 at least partially satisfies the targeted demographic of campaign parameters 112 may be made based on opportunity attributes 164 or from query results from user data store 180 from queries based on opportunity attributes 164.

Responsive to determining that the first opportunity attribute is associated with the first user attribute, select the network accessible device is selected to receive an advertisement by responding to the notice (block 375). In an example, ad engine 140 may send bid response 168 based on a calculated probability that ad slot notice 163 is associated with a target of an ad campaign. In the example, ad slot notice may not definitively identify network accessible device 145 and therefore ad engine 140 may fail to definitively match ad slot notice 163 to a user profile before bid response 168 is due (e.g., in 100-500 ms).

Verify whether the network accessible device is associated with at least a second user attribute associated with the ad campaign by sending a probe to the network accessible device (block 380). In an example, after successfully bidding on an ad slot, connection information to network accessible device 145 may be provided to ad engine 140. Ad engine 140 may then verify whether a user of network accessible device 145 is a target of an ad campaign prior to sending an ad to network accessible device 145. In an example, after network accessible device 145 is identified, ad engine 140 may recognize network accessible device 145 (e.g., based on IP address) from ad placements through a separate publisher (e.g., publisher 170). For example, ad daemon 147 may already be executing on network accessible device 145 from a previous ad placement through publisher 170. In another example, ad engine 140 may deploy ad daemon 147 to network accessible device 145, for example, via probe 148. In an example, ad engine 140 sends probe 148 to verify that a current user of network accessible device 145 is a target of an ad campaign. In an example, ad daemon 147 collects information on device attributes 149, including a make and model of network accessible device 145, as well as current and historical GPS data. In an example where ad daemon 147 was already executing on network accessible device 145, probe 148 may be a request for an updated status report from ad daemon 147, for example, to update potentially stale data to determine if an ad should be sent. For example, if network accessible device 145 only has 3G connection with no WiFI, a quality requirement of the smartphone campaign set by the manufacturer (e.g., to only show the ad in high definition) may not be met due to lack of bandwidth. In such an example, ad engine 140 may cancel sending the smartphone ad to network accessible device 145 based on the device status update from ad daemon 147.

Responsive to determining that the network accessible device is associated with the second user attribute, send the advertisement to the network accessible device for display (block 385). In an example, upon verifying via probe 148 that network accessible device 145 is a targeted device type for the smartphone ad, and/or that network accessible device 145 is a Chicago based device (e.g., through historical GPS data), ad engine 140 sends the smartphone ad to network accessible device 145. In an example, even if the original determination to send bid response 168 was based on inaccurate and/or erroneous data in opportunity attributes 164 or an inaccurate profile match from querying user data store 180, if probe 148 determines that network accessible device 145 and its user are correctly identified targets for the smartphone ad campaign, the smartphone ad is sent. For example, opportunity attributes 164 identifying network accessible device 145 as a New York device may be erroneous, and this error may be further compounded by a profile match in user data store 180 based on a shared username between a username for publisher 160 identified in opportunity attributes 164 and a record of the same username registered with publisher 170, but which actually belongs to a different individual. Nevertheless, if device attributes 149 collected by ad daemon 147 determine that network accessible device 145 is an appropriate target, then it will receive the smartphone ad. In an example, the smartphone ad is sent through publisher 160. In an example, a user profile for network accessible device 145's user may be created and/or updated in user data store 180 based on data collected by ad daemon 147 and/or probe 148.

Responsive to determining a lack of association between the network accessible device and the second user attribute, cancel sending the advertisement to the network accessible device (block 390). In an example, probe 148 determines that network accessible device 145 lacks association with a second user attribute targeted by campaign parameters 112. For example, device attributes 149 indicate that network accessible device 145 is the same model smartphone being advertised in the smartphone ad, and therefore the user of network accessible device 145 fails to match a second user attribute (e.g., potential buyers of the new smartphone) because the user has already bought the new smartphone. In the example, sending the smartphone ad to network accessible device 145 is canceled. In an example, probe 148 determines that network accessible device 145 is also unassociated with at least one opportunity attribute of opportunity attributes 164 reported to ad engine 140 by publisher 160. For example, publisher 160 reported that network accessible device 145 was a New York City device, but probe 148 verifies that the New York City residency is temporary.

In an example, taking advantage of the time probe 148 requires to return verification results for network accessible device 145's candidacy as a target for an ad campaign executed by ad engine 140, ad engine 140 solicits bids for the ad slot from publisher 160 via ad requests 116A-B to advertisers 114A-B. In an example, ad requests 116A-B are enriched with the provisional profile match results from querying user data store 180. For example, a profile match is made based on a username attribute in opportunity attributes 164 matching a username attribute registered with a different publisher in user data store 180. In the example, profile data from the potentially erroneous match may be included in ad requests 116A-B. In an example, the profile match is accurate and advertisers 114A-B may have higher quality information to bid on the ad slot than ad engine 140 did in the original auction. In an example, ad responses 118A-B are received prior to or shortly after results from probe 148. In an example, probe 148 times out and ad engine 140 defaults to the ad from the secondary auction without verification results from probe 148. In an example, each advertiser that ad engine 140 does not select to send an alternative ad (e.g., ad responses 118A and/or 118B timing out) may determine that it has failed to enter a winning bid. In an example, ad engine 140 cancels sending the smartphone ad to network accessible device 145 and substitutes instead an ad from an alternative ad campaign or an ad from advertisers 114A-B.

In an example, publisher 170 may send an ad slot notice to ad engine 140 along with opportunity attributes. In an example, ad engine 140 determines that a second network accessible device associated with the new ad slot notice is in Chicago based on GPS location data in the opportunity attributes sent with the new ad slot notice. In an example, based on the Chicago location, ad engine 140 enters a winning bid for the ad slot from publisher 170. In an alternative example, the opportunity data and/or probe results from probing the second network accessible device indicate that the second network accessible device is the new phone being advertised and therefore ad engine 140 determines that the second network accessible device should be passed over for displaying the smartphone ad. In the example, the first network accessible device (e.g., network accessible device 145) is an older model smartphone so the new smartphone is shown on network accessible device 145.

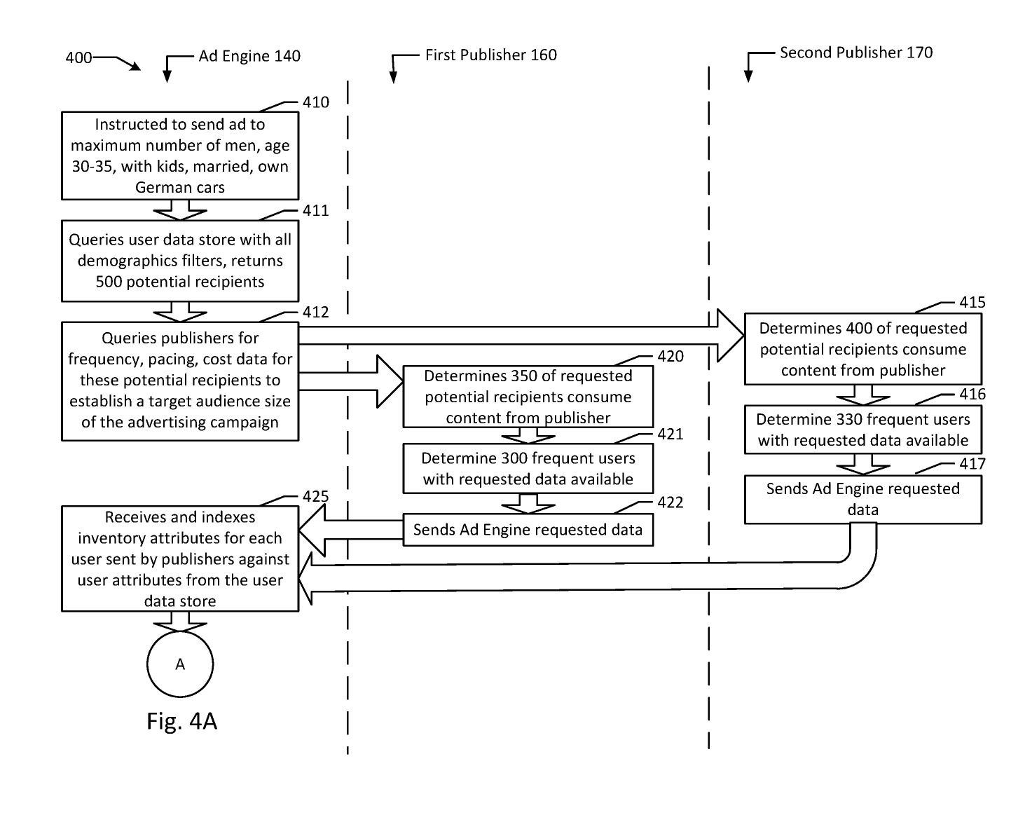

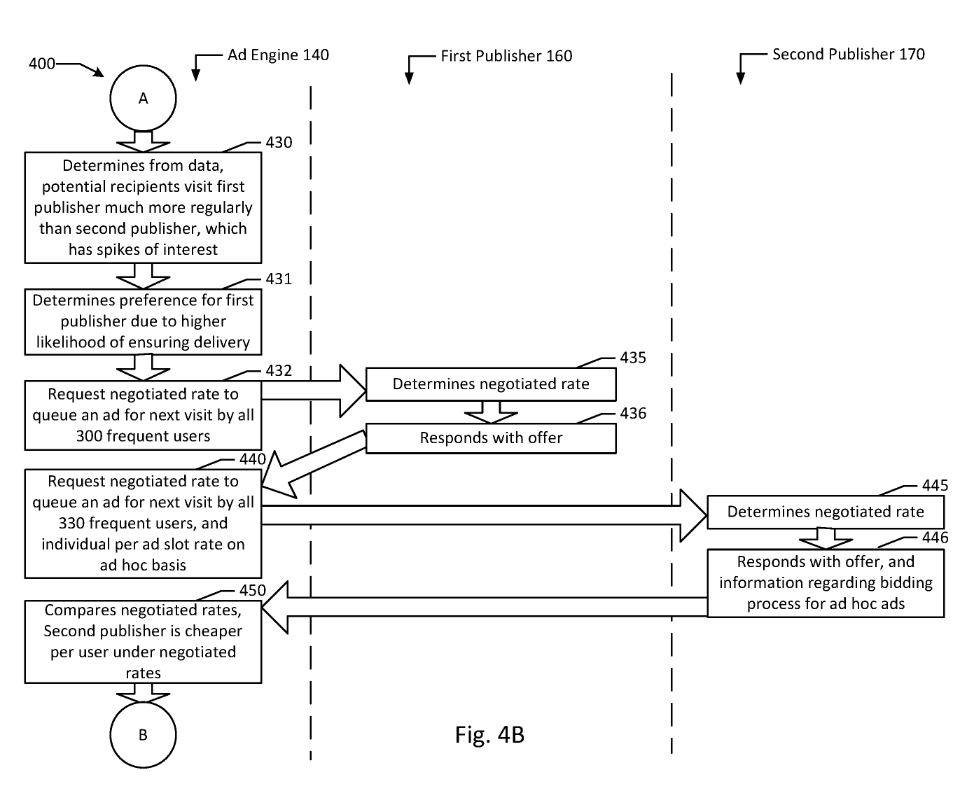

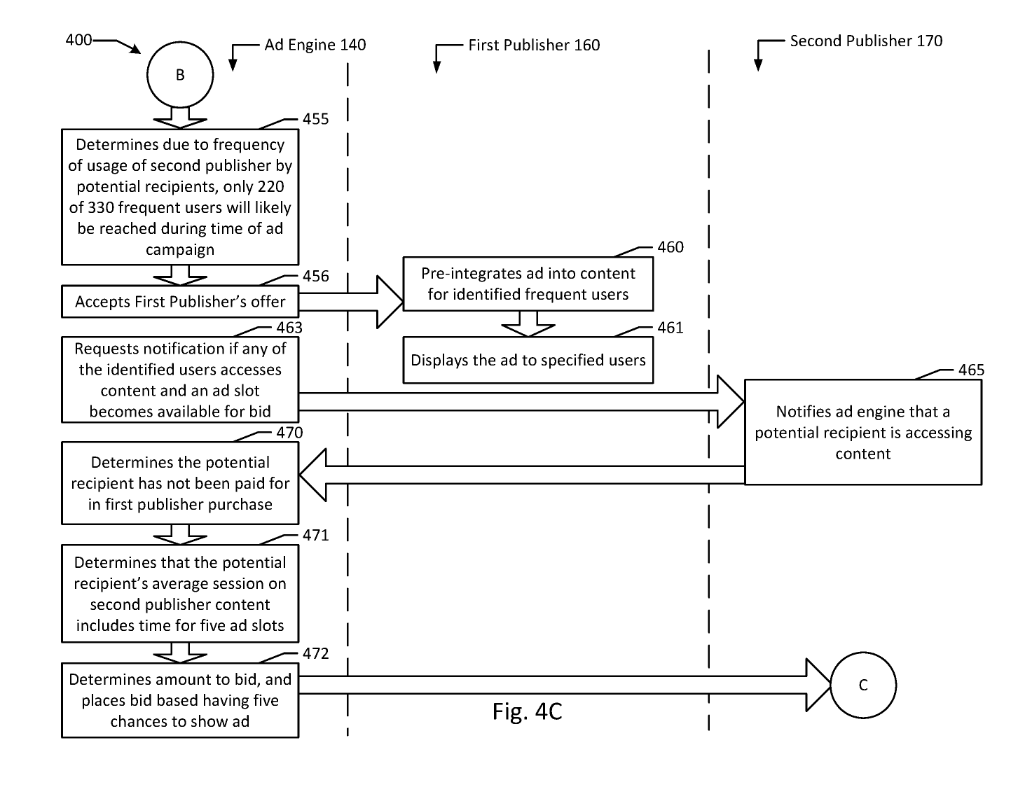

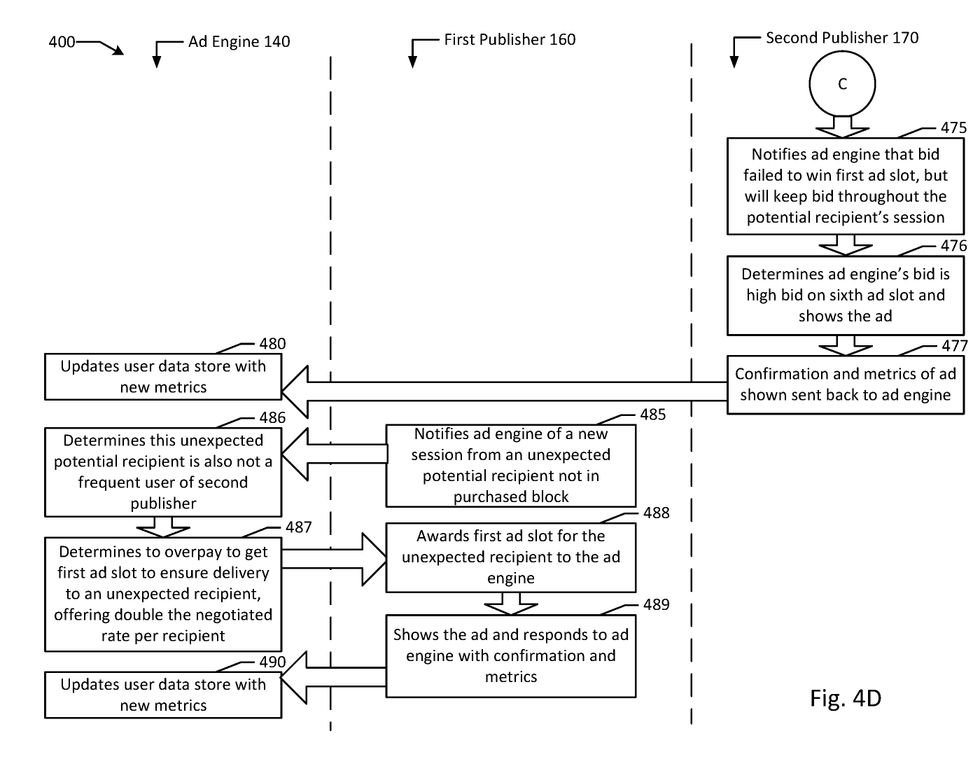

FIGS. 4A, 4B, 4C, and 4D are flow diagrams illustrating advertisement delivery and publisher selection in a system performing predictive analysis for controlling real-time advertising placements according to an example of the present disclosure. Although the examples below are described with reference to the flowchart illustrated in FIGS. 4A, 4B, 4C, and 4D, it will be appreciated that many other methods of performing the acts associated with FIGS. 4A, 4B, 4C, and 4D may be used. For example, the order of some of the blocks may be changed, certain blocks may be combined with other blocks, and some of the blocks described are optional. The methods may be performed by processing logic that may comprise hardware (circuitry, dedicated logic, etc.), software, or a combination of both. In example system 400, an advertisement engine 140 interfaces with a first publisher 160 and a second publisher 170 to execute an advertising campaign.

In an example as illustrated in FIG. 4A, ad engine 140 is instructed to send an advertisement to a maximum number of men, age 30-35, with kids, who are married, and own German cars (block 410). In the example, user data filter 131 may query user data store 180 with all of the above demographic filters returning 500 potential recipients of the advertisement (block 411). In an example, prediction engine 132 takes the list of 500 potential recipients and queries publishers 160 and 170 through inventory attribute engine 133 and publisher gateway 134 for frequency, pacing, and cost data for these potential recipients to establish a target audience size of the advertisement campaign (block 412). In an example, second publisher 170 may determine based on querying inventory database 222, that 400 of the requested potential recipients consume content 172 provided by second publisher 170 (block 415). In the example, second publisher 170 may determine that only 330 of the identified potential recipients are frequent enough consumers of content 172 for all of the data requested by ad engine 140 to be available (block 416). In an example, second publisher 170 may send ad engine 140 the requested data (block 417). Simultaneously, first publisher 160 may determine based on querying inventory database 220, that 350 of the requested potential recipients consume content 162 provided by first publisher 160 (block 420). In the example, first publisher 160 may determine that only 300 of the identified potential recipients are frequent enough consumers of content 162 for all of the data requested by ad engine 140 to be available (block 421). In an example, first publisher 160 may send ad engine 140 the requested data (block 422). In an example, inventory attribute engine 133 then receives and indexes inventory attributes for each user sent by publishers 160 and 170 against user attributes for each user from the user data store 180.

In an example as illustrated in FIG. 4B, ad engine 140 determines from the data sourced from publishers 160 and 170 and user data store 180 that the potential recipients visit the first publisher 160 much more regularly than the second publisher 170, which has spikes of interest rather than a steady flow (block 430). In an example, first publisher 160 may include content 162, which may be a web e-mail service that is checked on average on a daily basis by users of the e-mail service. In the example, second publisher 180 may be a sports blog whose traffic is driven by new articles especially those from a select few writers. In the example, ad engine 140 may determine a preference for first publisher 160 due to a higher likelihood of ensuring delivery of the advertisement to the targeted recipients (block 431). In an example, ad engine 140 may request a negotiated rate from first publisher 160 to queue an ad for a new high performance sports hatchback with room for kids in the back seat, to be placed for the next visit by each of the 300 frequent users of first publisher 160 identified in the list of targeted recipients (block 432). In an example, first publisher 160 determines a negotiated rate (block 435). First publisher 160 then responds to ad engine 140 with an offer (block 436). In an example, simultaneous with or subsequent to ad engine 140's negotiations with first publisher 160, ad engine 140 may request a negotiated rate to queue the same ad for the new high performance sports hatchback with room for kids in the back seat, to be placed for the next visit by each of the 330 frequent users of second publisher 170, and additionally request a preferential individual per ad slot rate on an ad hoc basis (block 440). In an example, second publisher 170 determines a negotiated rate (block 445). Second publisher 170 then responds to ad engine 140 with an offer for a negotiate rate as well as information regarding a bidding process for ad hoc ads (block 446). For example, second publisher 170 may respond with documentation for an application programming interface for bidding on ads or a list of supported bidding integrations. In an example, ad engine 140 compares the negotiated rates from both first publisher 160 and second publisher 170, and determines that second publisher 170 is cheaper on a per user basis under the negotiated rates (block 450).

In an example as illustrated in FIG. 4C, ad engine 140 further correlates frequency and pacing metrics received from publishers 160 and 170 related to each potential ad recipient and determines that due to the frequency of usage of second publisher 170's content 172 by the potential recipients, only 220 of the 330 frequent users will likely be reached during the projected two week ad campaign if second publisher 170 were selected (block 455). In the example, ad engine 140 accepts first publisher 160's offer (block 456). In an example, first publisher 160 then pre-integrates the ad into content 162 for the identified frequent users (block 460). When the specified users next access content 162, first publisher 160 displays the ad to the identified frequent users (block 461). In an example, ad engine 140 requests notification if any of the identified users access content 172 from second publisher 170, and an ad slot becomes available for bid (block 463). In an example, second publisher 170 notifies ad engine 140 that one of the potential recipients is accessing content (block 465). In an example, ad engine 140 determines that the potential recipient identified by second publisher 170 has not been paid for in the first publisher 160 block purchase for 300 frequent users (block 470). In an example, based on historical data, ad engine 140 determines that the potential recipient's average session on second publisher 170's content 172 included time for five ad slots (block 471). In the example, ad engine 140 may determine an amount to bid, and place a bid based on having five chances to show the ad (block 472).

In an example as illustrated in FIG. 4D, second publisher 170 may inform ad engine 140 that ad engine 140's bid failed to win the first ad slot, but the bid will be kept throughout the potential recipient's session for subsequent ad slots (block 475). In other examples, second publisher 170 may require new bids for each ad slot and/or multiple rounds of bidding on each ad slot. In an example, second publisher 170 determines that ad engine 140's bid is the high bid on a sixth ad slot of the potential recipient's session and shows the ad (block 476). In an example, second publisher 170 sends ad engine 140 a confirmation that the ad has been shown to the potential recipient, including metrics related to the consumption of the ad by the potential recipient (block 477). In an example, ad engine 140 updates user data store 180 with the newly received metrics (block 480).

In an example, first publisher 160 may have retained the original list of 500 users from ad engine 140's query. In the example, first publisher 160 notifies ad engine 140 that a new session has been established by an unexpected potential recipient who was not included in the purchased block of frequent users (block 485). In an example, ad engine 140 may determine that the unexpected potential recipient identified by first publisher 160 is also not a frequent user of the second publisher (block 486). In the example, ad engine 140 may determine that it is unlikely for either publisher to have an ad slot with the unexpected potential recipient again during the duration of the ad campaign. Ad engine 140 may therefore determine to overpay to get the first ad slot for the unexpected potential recipient to ensure delivery to the unexpected recipient by offering double the negotiated rate per recipient to first publisher 160 for the first ad slot in the unexpected recipient's session viewing content 162 (block 487). In an example, first publisher 160 then awards the first ad slot for the unexpected recipient to ad engine 140 (block 488). In an example, first publisher 160 shows the ad to the unexpected recipient and responds to ad engine 140 with a confirmation that the ad was shown along with metrics related to the consumption of the ad by the unexpected recipient (block 489). In an example, ad engine 140 updates user data store 180 with the newly received metrics (block 490).

In various examples, campaign executor 136 may serve multiple different versions of an advertisement tailored to the particular recipient of the ad. In some examples, these versions may be pre-formatted and assigned to each potential recipient after user attribute filtering is performed. In other examples, versions and sub-versions of the advertisement may be dynamically adjusted based on user and/or inventory attributes associated with a particular potential recipient. For example, with better advertisement targeting, a user may be exposed to less advertisements total, while producing similar purchase rates of advertised products. By reducing the number of advertisements displayed, battery usage and network data usage of network accessible devices may be reduced, thereby also reducing energy wasted as heat. Advertisements tend to be graphically intensive, and therefore tend to consume more compute resources to display than the content featuring the advertisements, so a reduction in overhead spent displaying advertisements allows for longer and smoother operation of a network accessible device as a content distributor. In addition, with real-time updates of consumption metrics forwarded to campaign executor 136, engagement statistics for advertisements may be better computed for an advertising agency, resulting in more efficient advertising campaigns. With increased efficiency, and targeting based on the predicted needs of a user, advertisements may also become more of a helpful tool in a shopping experience rather than an annoyance to be dealt with by a user. By enabling automated, custom, bespoke advertising, advertising based on real-time audience takes advertising beyond solicitation and into creative content generation. For example, an ad for a car may display on terrain similar to a recipient's geography (e.g., based on a zip code user attribute), and be in the recipient's native tongue (e.g., based on a operating system language setting user attribute). An ad for a pair of shoes may be shown on a model or mannequin wearing a dress recently purchased by the recipient (e.g., based on browser history user attributes, which may include purchase history). In an example, potentially after additional user identity verification from the network accessible device in use, ads may even be tailored to address the recipient by name (e.g., based on a personal contact user attribute), and include expedited purchasing features (e.g., based on stored payment option user attributes). In addition, with more accurate predictions regarding the number of advertisements that require delivery for a given ad campaign (e.g., based on targeting specific users predisposed to higher conversion rates), campaign executor 136 may be required to deliver significantly less total advertisements thereby greatly reducing the bandwidth required to serve the advertisements.

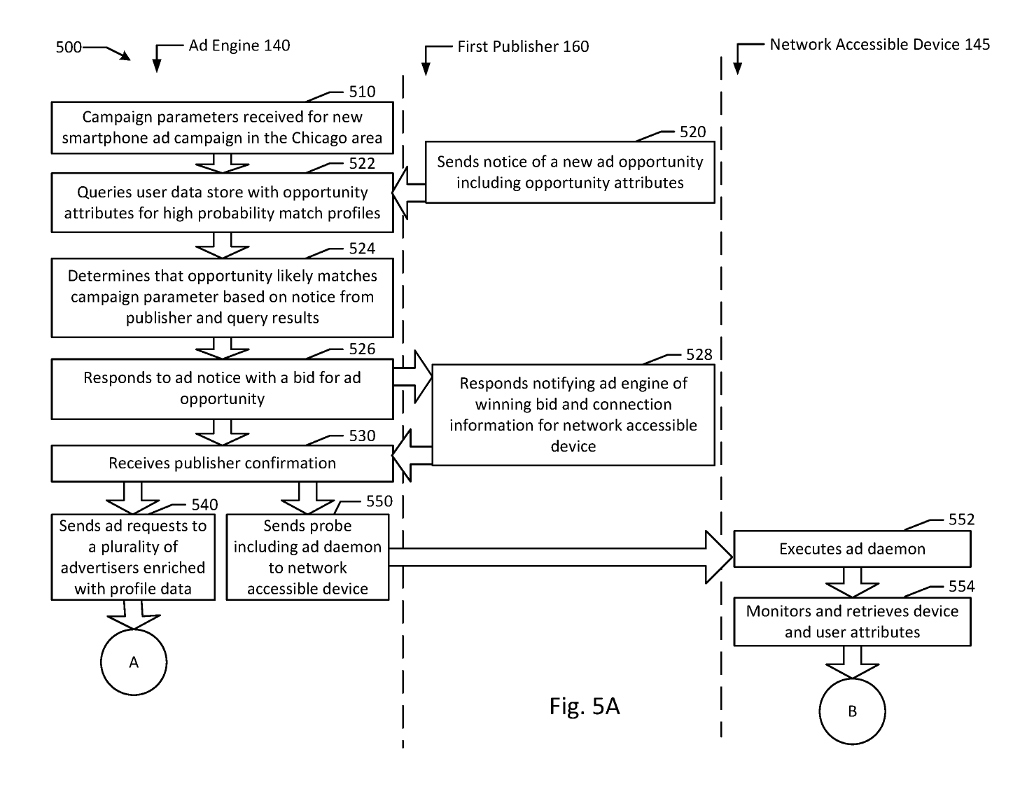

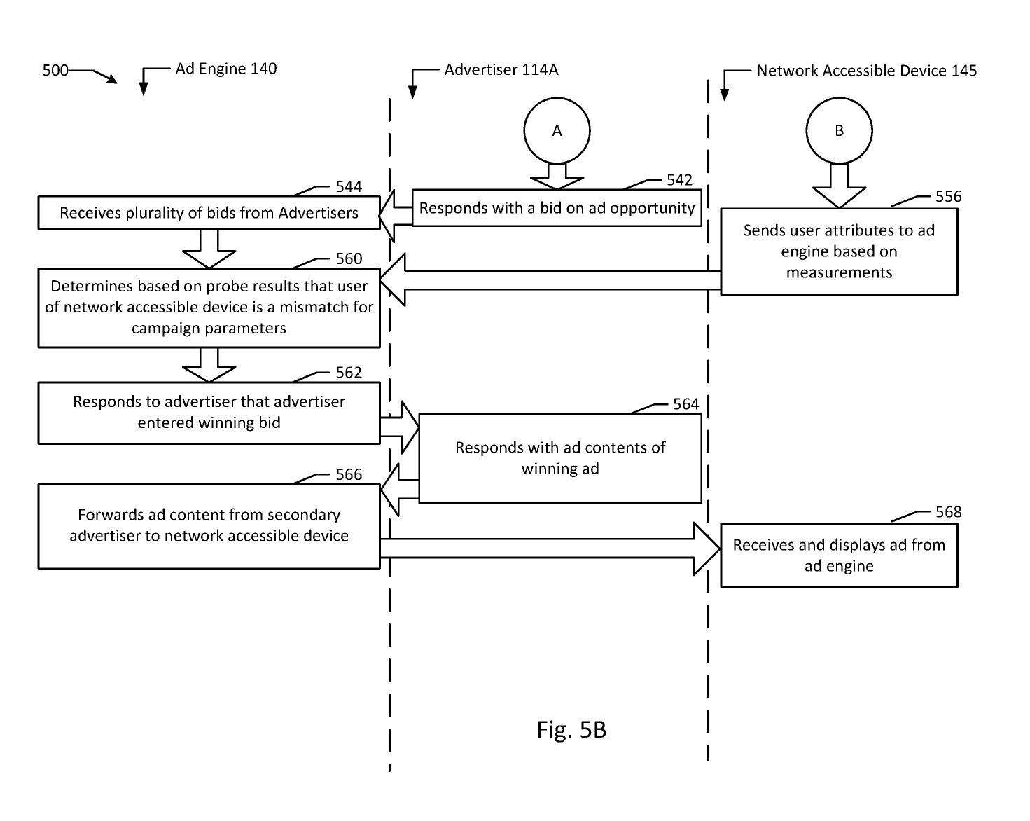

FIGS. 5A and 5B are flow diagrams illustrating advertisement delivery in a system performing verified predictive analysis for controlling real-time advertising placements according to an example of the present disclosure. Although the examples below are described with reference to the flowchart illustrated in FIGS. 5A and 5B, it will be appreciated that many other methods of performing the acts associated with FIGS. 5A and 5B may be used. For example, the order of some of the blocks may be changed, certain blocks may be combined with other blocks, and some of the blocks described are optional. The methods may be performed by processing logic that may comprise hardware (circuitry, dedicated logic, etc.), software, or a combination of both. In example system 500, an advertisement engine 140 interfaces with a first publisher 160 and a network accessible device 145 to execute verification of a predicted target for receiving an ad.

In an example as illustrated in FIG. 5A, ad engine 140 receives campaign parameters 112 associated with a smartphone ad campaign in the Chicago area (block 510). In the example, ad engine 140 is operated by a primary advertiser bidding on ad opportunities to execute the ad campaign with a plurality of publishers 160 and 170. In an example, first publisher 160 later sends ad slot notice 163 to notify ad engine 140 of a new ad opportunity with opportunity attributes 164 (block 520). In an example, ad engine 140 queries user data store 180 with opportunity attributes 164 to obtain high probability match user profiles for a user accessing content that generated ad slot notice 163 (block 522). In an example, ad engine 140 determines that the new ad opportunity is likely a match for the smartphone campaign's target demographic based on opportunity attributes 164 and/or results from querying data store 180 (block 524). Based on determining that the user is likely Chicago based, ad engine 140 responds to ad slot notice 163 with a bid for the associated ad opportunity (block 526). In the example, publisher 160 notifies ad engine 140 that it has entered a winning bid on the ad opportunity and forwards information for establishing a connection to network accessible device 145 (block 528). In an example, ad engine 140 receives the publisher confirmation (block 530).

In an example, ad engine 140 solicits bids in a secondary auction for the ad slot from publisher 160 via ad requests 116A-B to a plurality of secondary advertisers 114A-B, where the ad requests 116A-B are translated from ad slot notice 163 to include additional information from the query results of querying data store 180 with opportunity attributes 164 (block 540). In an example, substantially simultaneously with soliciting bids from advertisers 114A-B, and shortly after receiving confirmation of winning the ad slot from publisher 160, ad engine 140 seconds probe 148 including a copy of the executable code of ad daemon 147 to network accessible device 145 (block 550). In the example, network accessible device 145 executes ad daemon 147 (block 552). In the example, ad daemon 147 monitors and retrieves device attributes 149 and/or user attributes to provide data for verify whether network accessible device 145 is a candidate for the smartphone ad campaign (block 554). In an example where ad daemon 147 is already executing on network accessible device 145, for example, due to an ad placement on network accessible device 145 via a publisher 170, information gathered from ad daemon 147 may be included in ad requests 116A-B sent to secondary advertisers 114A-B. In an example, the previous verification for the publisher 170 ad slot may have been for a separate campaign with different targeted user attributes, so probe 148 may be querying for previously unverified attributes. In an example, probe 148 returns results with sufficient remaining time for ad engine 140 to send a further enriched ad request (e.g., based on a response to probe 148) to a third secondary advertiser. For example, publisher 160 may present a 750 ms time window for an ad to start loading to network accessible device 145. In the example, ad engine 140 bids on the ad within 100 ms and receives confirmation of winning the ad slot with 500 ms remaining in the original 750 ms window. In an example, probe 148 may return results within 300 ms, therefore leaving just under 200 ms to request for bids with a third secondary advertiser. In the example, ad responses 118A-B may be received prior to results returning from probe 148, but a winner of the secondary auction is not notified until the third secondary advertiser either times out entering a bid or a bid is received from the third secondary advertiser.

In an example as illustrated in FIG. 5B, advertiser 114A responds to ad request 116A with a bid (e.g., ad response 118A) on the ad opportunity from publisher 160 (block 542). In the example, ad response 118A is one of a plurality of bids from advertisers 114A-B (block 544). In an example, while waiting on the plurality of ad responses 118A-B, network accessible device 145 sends a report including measured and verified user attributes of network accessible device 145's user to ad engine 140 (block 556). In an example, the probe results to network accessible device 145 indicate that, for example, an unrecognized device identifier in opportunity attributes 164 actually corresponds to the smartphone being advertised in the campaign and therefore the user of network accessible device 145 is a mismatch for campaign parameters 112 (block 560). Ad engine 140 then notifies advertiser 114A that it entered the winning bid prior to a timeout associated with ad response 118A (block 562). In the example, advertiser 114A responds to ad engine 140 with the ad contents of the winning ad (block 564). Ad engine 140 forwards the ad content from advertiser 114A to network accessible device 145 (block 566). In an example, publisher 160 may act as an additional intermediary between advertiser 114A and network accessible device 145. In an example, network accessible device 145 receives the ad content and displays the ad (e.g., advertiser 114A's ad) from ad engine 140 (block 568).

Verified predictive analysis for controlling real-time advertising placements further enhances the efficiency benefits of conducting advertising campaigns with predictive analysis based on a user data store of user profiles. For example, ad placements based on real-time bidding are often bid on with incomplete and/or inaccurate data regarding the device where the ad will be displayed and the user consuming the ad. Predictive analysis allows the universe of user profile records associated with a given ad campaign to be reduced by orders of magnitude thereby speeding up queries. By enabling the cancellation of ad delivery in cases where earlier predictive analysis selecting an advertising target generates a mismatch, computing resources may be saved resulting in a more efficient ad delivery system. In addition, even a proper predictive match may lead to a user whose device is not in a state to receive the ad, for example, the user is connected only on 3G cellular and the network bandwidth of the connection would not support the video ad the device was targeted for. Aborting the sending of the ad saves on network bandwidth for transferring the video to cellphone towers near the network accessible device that would be incapable of playing the ad.

It will be appreciated that all of the disclosed methods and procedures described herein can be implemented using one or more computer programs or components. These components may be provided as a series of computer instructions on any conventional computer readable medium or machine readable medium, including volatile or non-volatile memory, such as RAM, ROM, flash memory, magnetic or optical disks, optical memory, or other storage media. The instructions may be provided as software or firmware, and/or may be implemented in whole or in part in hardware components such as ASICs, FPGAs, DSPs or any other similar devices. The instructions may be executed by one or more processors, which when executing the series of computer instructions, performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A system comprising:
a plurality of publishers including a first publisher and a second publisher;
a user profile repository storing a plurality of user profiles associated with a plurality of users, wherein the plurality of users is associated with a plurality of network accessible devices, and wherein each of the plurality of user profiles includes a respective plurality of user attributes; and
an advertisement engine executing on one or more processors to:
receive, from the first publisher, a first notice of a first ad opportunity associated with a first network accessible device, wherein the first notice includes a first plurality of opportunity attributes;
query the user profile repository based on the first plurality of opportunity attributes;
determine, based on at least one of the first notice and a results of querying the user profile repository, that a first opportunity attribute of the first plurality of opportunity attributes is associated with a first user attribute associated with an ad campaign;
responsive to determining that the first opportunity attribute is associated with the first user attribute, respond to the first publisher to select the first network accessible device to receive a first advertisement;
verify whether the first network accessible device is associated with at least a second user attribute associated with the ad campaign by sending a probe to the first network accessible device;
responsive to determining that the first network accessible device is associated with the second user attribute, send the first advertisement to the first network accessible device for display; and
responsive to determining a lack of association between the first network accessible device and the second user attribute, cancel sending the first advertisement to the first network accessible device.

2. The system of claim 1, wherein the advertisement engine selects a secondary advertiser of a plurality of secondary advertisers and a second advertisement of the secondary advertiser is displayed on the first network accessible device.

3. The system of claim 2, wherein the advertisement engine sends a plurality of advertisement requests to the plurality of secondary advertisers before receiving a results of probing the first network accessible device.

4. The system of claim 2, wherein canceling the first advertisement includes requesting the second advertisement to be displayed on the first network accessible device.

5. The system of claim 1, wherein an ad daemon executes on the first network accessible device to monitor and report on user attributes of a user of the first network accessible device.

6. The system of claim 5, wherein the ad daemon is sent to the first network accessible device by the advertisement engine in conjunction with an initial probing of the first network accessible device.

7. The system of claim 5, wherein the advertisement engine sends a request for a device status update to the ad daemon prior to sending the first advertisement.

8. The system of claim 7, wherein the advertisement engine cancels sending the first advertisement based on the device status update.

9. The system of claim 1, wherein the first opportunity attribute included in the first notice is inaccurate.

10. The system of claim 9, wherein the results of querying the user profile repository is a first user profile, and the first opportunity attribute is corrected based on the first user profile.

11. The system of claim 1, wherein the probe determines that the first network accessible device lacks association with the first opportunity attribute.

12. The system of claim 1, wherein the advertisement engine further executes to:
receive, from a second publisher, a second notice of a second ad opportunity, wherein the second notice includes a second plurality of opportunity attributes; and
determine, based on the user profile repository and the second notice that the second notice is associated with a second network accessible device sharing the first user attribute.

13. The system of claim 12, wherein the second network accessible device is selected for displaying the first advertisement based on sharing the first user attribute with the first network accessible device.

14. The system of claim 12, wherein the second network accessible device is passed over for displaying the first advertisement based on a third user attribute of the second network accessible device unshared with the first network accessible device.

15. The system of claim 1, wherein the first publisher acts as a conduit through which the first advertisement is sent to the first network accessible device.

16. A method comprising:
receiving a notice of an ad opportunity associated with a network accessible device, wherein the notice includes a plurality of opportunity attributes;
querying a user profile repository based on the plurality of opportunity attributes;
determining based on at least one of the notice and a results of querying the user profile repository, that a first opportunity attribute of the plurality of opportunity attributes is associated with a first user attribute associated with an ad campaign;
responsive to determining that the first opportunity attribute is associated with the first user attribute, responding to the notice to select the network accessible device to receive an advertisement;
verifying whether the network accessible device is associated with at least a second user attribute associated with the ad campaign by sending a probe to the network accessible device;
responsive to determining that the network accessible device is associated with the second user attribute, send the advertisement to the network accessible device for display; and
responsive to determining a lack of association between the network accessible device and the second user attribute, cancel sending the advertisement to the network accessible device.

17. A system comprising:
a first plurality of network accessible devices including a first network accessible device and a second network accessible device, wherein each network accessible device of the plurality of network accessible devices is associated with at least one respective user, including a first user associated with the first network accessible device, and a second user associated with the second network accessible device;
a first plurality of user attributes associated with the first user, including a first user attribute and a second user attribute;
a second plurality of user attributes associated with the second user, including a third user attribute and a fourth user attribute;
a plurality of publishers including a first publisher and a second publisher;
a first plurality of inventory attributes associated with the first publisher;
a second plurality of inventory attributes associated with the second publisher;
one or more processors communicatively coupled with a network; and
an advertisement engine executing on the one or more processors to:
determine a quantity of network accessible devices in a second plurality of network accessible devices, wherein each network accessible device of the second plurality of network accessible devices is associated with at least one user associated with at least one user attribute that is shared among each of the second plurality of network accessible devices, the second plurality of network accessible devices including at least the first network accessible device and the second network accessible device;
select, based on the first plurality of user attributes, the first user to receive an advertisement;
select the first publisher to deliver the advertisement to the first user based on a comparison of the first plurality of inventory attributes and the second plurality of inventory attributes;
reserve, from the first publisher, a first advertisement slot to send the advertisement to the first network accessible device;
send, by the advertisement engine, the advertisement to the first network accessible device;
determine whether a target audience size for the advertisement has been fulfilled;
responsive to determining that the target audience size for the advertisement is fulfilled, report a consumption result of the advertisement; and
responsive to determining that the target audience size for the advertisement is unfulfilled, select, based on the second plurality of user attributes, the second user to receive the advertisement;
select the first publisher to deliver the advertisement to the second user based on a comparison of the first plurality of inventory attributes and the second plurality of inventory attributes;
reserve, from the first publisher, a second advertisement slot to send the advertisement to the second network accessible device; and
send, by the advertisement engine, the advertisement to the second network accessible device.

18. The system of claim 17, wherein the first plurality of inventory attributes includes attributes based on at least one of a cost of the first advertisement slot, a cost of the second advertisement slot, a frequency of interaction between the first user and the first publisher, a frequency of interaction between the second user and the first publisher, a pacing of interactions between the first user and the first publisher, a pacing of interactions between the second user and the first publisher.

19. The system of claim 17, wherein a third network accessible device of the plurality of network accessible devices is associated with a third user, the third user is associated with a third plurality of user attributes, and the third user is selected to receive the advertisement, wherein the advertisement engine bids on a third advertisement slot from one of the first publisher and the second publisher to send the advertisement to the third network accessible device but fails to enter a winning bid, wherein a first amount bid by the advertisement engine on the third advertisement slot is based on a frequency of interaction between the third user and the first publisher and a pacing of interactions.

20. The system of claim 19, wherein a second amount bid by the advertisement engine on a fourth advertisement slot from the first publisher to send the advertisement to the third network accessible device successfully reserves the fourth advertisement slot, wherein the second amount bid is less than or equal to the first amount bid.

21. The system of claim 17, wherein the advertisement engine determines the target audience size based on an advertising budget of an advertising campaign, the first plurality of inventory attributes, and the second plurality of inventory attributes.

22. The system of claim 21, wherein the first plurality of inventory attributes include user specific inventory attributes associated with a plurality of users respectively associated with network accessible devices of the plurality of network accessible devices.

23. The system of claim 21, wherein the advertisement engine calculates the target audience size based on a probability of successfully reserving advertisement slots from the first publisher to send the advertisement to each network accessible device of the plurality of network accessible devices based on the advertising budget.

24. The system of claim 17, wherein the inclusion of the first network accessible device in the plurality of network accessible devices is based on the first plurality of user attributes, wherein the first plurality of user attributes identify the first user as a member of a target demographic.

25. The system of claim 24, wherein the first plurality of user attributes includes at least one of a gender, an age, a race, a marital status, an income, a browsing history, a home ownership status, disabilities, a level of education, a employment status, an occupation, a status of dependents, a head of household status, a location, a means of transportation, an amount of savings, a religion, and a contractual relationship.

26. The system of claim 17, wherein the first plurality of user attributes is obtained from a hypertext transfer protocol cookie.

27. The system of claim 17, wherein a third network accessible device of the first plurality of network accessible devices is associated with a third user, the third user being associated with a third plurality of user attributes including a fifth user attribute.

28. The system of claim 27, wherein the third network accessible device is included in the second plurality of network accessible devices responsive to determining that the first user attribute, the third user attribute and the fifth user attribute match each other, the advertisement engine further executing to:
add the second user attribute as a required shared attribute among members of the second plurality of network accessible devices;
determine that the third plurality of user attributes lacks a sixth user attribute matching the second user attribute;
responsive to determining that the third plurality of user attributes lacks a sixth user attribute matching the second user attribute, remove the third network accessible device from the second plurality of network accessible devices.

29. The system of claim 17, wherein a first weighted score based on the first plurality of inventory attributes is compared with a second weighted score based on the second plurality of inventory attributes, wherein the first weighted score is weighted based on prioritizing at least one inventory attribute of the first plurality of inventory attributes.

30. The system of claim 29, wherein the at least one inventory attribute being prioritized is one of: (i) a cost per advertisement, (ii) a probability of reaching a specific user, (iii) a relationship between the first publisher and a content of the advertisement, (iv) a length of time necessary to reach a specific user, and (v) a quantity of network accessible devices of the second plurality of network accessible devices that regularly interface with the first publisher.

31. The system of claim 17, wherein the first network accessible device reports a first proportion of the advertisement that was consumed by the first user and the second network accessible device reports a second proportion of the advertisement that was consumed by the second user, wherein the first proportion is based on at least one of a duration the advertisement was viewed, a duration of the advertisement that was successfully transmitted, and a subsequent action taken by the first user in response to the advertisement.

32. The system of claim 17, wherein the consumption result of the advertisement is reported to at least one of an advertiser, an advertisement agency, and the first publisher.

33. The system of claim 17, wherein the advertisement engine further executes to:
determine whether a predetermined time period has elapsed between a first time when the first network accessible device received the advertisement in the first advertisement slot and a second time when a third advertisement slot becomes available; and
responsive to determining that the predetermined time period has elapsed, reserve the third advertisement slot to send the advertisement to the first network accessible device.
